(19) United States
(12) Patent Application Publication
(10) Pub. No.: US 2026/0304541 A1
(43) Pub. Date: Oct. 1, 2026

(54) METHODS AND APPARATUS FOR CONTROLLING NCR FORWARDING

(71) Applicant: Samsung Electronics Co., Ltd., Suwon-si, Gyeonggi-do (KR)

(72) Inventors: Jonas SEDIN, Staines (GB); June HWANG, Suwon-si (KR); Milos TESANOVIC, Staines (GB)

(21) Appl. No.: 19/167,155

(22) PCT Filed: Mar. 25, 2024
(86) PCT No.: PCT/KR2024/003672

§ 371 Date: Sep. 19, 2025

(30) Foreign Application Priority Data
Mar. 24, 2023 (GB) 2304386.2
May 12, 2023 (GB) 2307127.7

(51) Int. Cl. H04W 76/27; H04W 84/04

(52) U.S. Cl. CPC H04W 76/27; H04W 84/042

(57) ABSTRACT

The disclosure relates to a 5G or 6G communication system for supporting a higher data transmission rate. According to various examples of the present disclosure, there is provided a method, of a repeater node configured to perform a forwarding function in a network, comprising: while communicably connected to a first network entity in the network, detecting a change in a link with the first network entity; and modifying the forwarding function based on detecting the change.

### TECHNICAL FIELD

Certain examples of the present disclosure relate to techniques for controlling a forwarding function of a repeater node. For example, certain examples of the present disclosure provide methods, apparatus and systems for controlling a forwarding function (NCR-Fwd) of a Network Control Repeater (NCR) in a 3^{rd} Generation Partnership Project (3GPP) 5^{th} Generation (5G) New Radio (NR) network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user con-venience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The content of the following documents is referred to below and/or their content provides background information that the following disclosure should be considered in the context of:
[1] 3GPP TS 38.321; 5G; NR; Medium Access Control (MAC) protocol specification;
Release 17 (e.g., V17.3.0);
[2] 3GPP TS 38.331; 5G; NR; Radio Resource Control (RRC); Protocol specification
Release 17 (e.g., V17.3.0);
[3] 3GPP TS 38.304; 5G, NR, User Equipment (UE) procedures in idle mode and in RRC Inactive state;
Release 17 (e.g., V17.3.0)

(Note: the example versions shown for each TS are non-limiting, other versions of the TS may be considered also)

Wireless or mobile (cellular) communications networks in which a mobile terminal (e.g., user equipment (UE), such as a mobile handset) communicates via a radio link with a network of base stations, or other wireless access points or nodes, have undergone rapid development through a number of generations. The 3rd Generation Partnership Project (3GPP) design, specify and standardise technologies for mobile wireless communication networks. Fourth Generation (4G) and Fifth Generation (5G) systems are now widely deployed.

3GPP standards for 4G systems include an Evolved Packet Core (EPC) and an Enhanced-UTRAN (E-UTRAN: an Enhanced Universal Terrestrial Radio Access Network). The E-UTRAN uses Long Term Evolution (LTE) radio technology. LTE is commonly used to refer to the whole system including both the EPC and the EUTRAN, and LTE is used in this sense in the remainder of this document. LTE should also be taken to include LTE enhancements such as LTE Advanced and LTE Pro, which offer enhanced data rates compared to LTE.

In 5G systems a new air interface has been developed, which may be referred to as 5G New Radio (5G NR) or simply NR. NR is designed to support the wide variety of services and use case scenarios envisaged for 5G networks, though builds upon established LTE technologies. New frameworks and architectures are also being developed as part of 5G networks in order to increase the range of functionality and use cases available through 5G networks.

In order to provide enhanced network coverage, a variety of different types of network nodes have been developed. For example, a Radio Frequency (RF) repeater may be deployed to amplify and forward any signal that it receives to supplement coverage provided by a regular cell. An enhanced type of repeater node, called a Network-Controlled Repeater (NCR), is currently under development and is a Release 18 Study Item/Work Item (3GPP RP-213700).

FIG. 1 illustrates the network architecture of NCR communication. As shown, the NCR 100 receives and forwards signals from a base station (e.g. a 5G NR base station, such as a gNB) to a target UE, User Equipment, via an NCR-Fwd link. The NCR also receives control signals from gNB via a control link, terminating at a NCR-Mobile Termination (MT) node. These control signals are used by the NCR-MT to configure the NCR. Once configured, the NCR 100 provides an amplify-and-forward function (NCR-Fwd) between the gNB (via backhaul link) and the UE (via access link) that is transparent to the UE. Accordingly, the gNB may communicate with the UE directly or through an NCR.

The NCR-MT control link is intended to function similarly to a UE. Therefore, the NCR-MT has a full protocol stack to correspond to the UE control plane stack, and NCR configurations are signalled and configured similarly to those for a UE. The NCR-MT may therefore be configured to search for serving cells, initiate and perform RRC signalling, transfer NCR capabilities, register to the network, and perform au-thentication. However, some functionality normally used by a UE may not be applicable to the NCR, and will not be implemented by NCR-MT and/or configured by the network.

RRC protocol, as supported by the NCR, defines modes (or states) of behaviour for a UE according to resource: RRC_Connected, RRC_Idle and RRC_Inactive. In RRC_Connected, the UE is assigned and communicating with a serving base station (e.g., gNB). In RRC_Idle, the UE is in a standby state and is not assigned to a serving base station. The UE camps on, that is, monitors a control channel of, a serving cell, wherein received incoming signals can be utilised during a cell reselection procedure. The UE can initiate RRC Connection establishment to the gNB and move from RRC_Idle to RRC_Connected. As indicated, as the configurations of the NCR correspond to those of a UE, and the NCR supports RRC protocol, and also supports RRC Connected, RRC idle and RRC inactive modes.

Radio Link Failure (RLF) procedures are introduced to allow a UE (or NCR) to regain its radio link to a/another base station (e.g. gNB) in case the radio link fails. After having been triggered, the UE performs RRC re-establishment, which means that the UE performs cell selection to potentially find a new cell (the same cell is a possible outcome) and connect to the new cell.

Radio Link Failure can be declared in a number of cases. In a first example, referring to FIG. 2a, the UE measures the cell strength through Radio Link Monitoring. If the cell strength is measured to be below a certain threshold, resulting in out of sync indications (e.g., from a lower layer(s)), step 1) for a pre-configurable amount of times (N310), e.g. N310=four, the UE triggers a timer (T310) for the UE to recover. If it does not recover, the UE declares a Radio Link Failure (RLF). For the UE to recover (i.e. the recover condition) in-sync indications are received (e.g., from a lower layer(s)) for a pre-configurable amount of times (N311) during the T310 timer duration. This is illustrated in FIG. 2b, where UE detects/receives in-sync indications (e.g., from lower layers, based on transmission(s) received by the UE from the gNB). In particular, in the example shown, two in-sync indications are received (corresponding to the recover condition), where timer T310 is stopped, and RRC connection is continued. In this case, no RLF is triggered in response to timer T310.

Further examples of Radio Link Failure may include:
RLC PDUs are re-transmitted a number of times;
   The network configures a number of times (maxRetxThreshold) that an RLC PDU may be attempted to be re-transmitted.
Random access problems;
   This can occur when the UE is in connected mode and the UE is trying to re-synchronize, for instance after losing uplink synchronization.
Backhaul (BH) RLF (Integrated Access and Backhaul, IAB related);
   Failure of backhaul links.
Uplink Listen Before Talk (LBT) failure;
   This is when the UE fails LBT when on unlicensed band.

As part of performing Radio Link Failure, the UE can be configured to gather an RLF-Report which contains information regarding the radio link failure, which then can be reported to the gNB where the RLF occurred, or to another gNB.

In some circumstances, such as when RRC re-establishment fails, or if the UE has not yet activated AS security, the UE may have to leave connected mode under the release cause ‘RRC Connection Failure’. The release cause is relayed to upper layers of the UE-NAS in this case. The action in NAS upon entering RRC idle mode with this release cause is to trigger a Tracking Area Update to any cell according to idle mode procedures.

The RRC Re-establishment procedure is performed after RLF in most cases. It may also be performed when a UE fails a handover, as well as in cases of configuration failure. The RRC Re-establishment procedure is illustrated in FIG. 3, wherein the steps are as follows:
1. RLF is declared (e.g. according to any of the above-described examples of Radio Link Failure), or handover failure.
2. Idle mode (RRC_Idle) cell selection procedure
3. (First performing random access and) Sending RRC Re-establishment request
4. The new gNB retrieving UE context from old gNB (if the gNB is not the same as old, following cell selection)
5. Old gNB returning the UE context
6. New gNB replies with RRC Re-establishment and potentially reconfigures UE if needed, or continues using the same RRC configuration as previous configuration (old gNB)
a. If reconfiguring the UE, the gNB replies with RRCSetup
7. UE returning with RRC re-establishment is complete

To indicate to an old gNB that a previously associated/connected UE has failed, the new gNB may signal a so-called RLF indication to the old gNB via the Xn interface. The RLF indication can, for example, contain the RLF-Report compiled by the UE. This procedure can be seen in FIG. 4.

An RRC resume procedure is performed to bring a UE out of the RRC inactive state. RRC Resume is started by the UE first synchronizing via random access and then transmitting RRCResumeRequest (i.e. RRCResumeRequest message/signal/transmission etc.) which contains the identifier of the UE, the i-RNTI, which is specifically used for RRC inactive. If the gNB is able to locate the UE context, i.e the configuration of the UE, the gNB will reply with RRCResume, which may for instance contain a full configuration (else UE will used stored UE Inactive AS context for the connected mode configuration). The UE will restore security and the previous RRC configuration and then send the RRCResumeComplete. Upon completion of the procedure the UE will have completed the RRC Resume procedure.

The RRC resume procedure can be triggered (e.g. (1) FIG. 4b) in a number of ways:
UE initiated:
   There is uplink traffic in the UE buffer. In this case the resume cause value used is mt-Access
   RAN Notification Area Update. This is triggered when the UE in RRC inactive camps on a cell which has a RAN-AreaCode which is not part of the UEs RAN Notification Area. The UEs RAN Notification Area is configured to a UE as part of the RRCRelease message when released to RRC inactive
   Expiry of timer T380, the periodic RAN Notification Area Update (RNAU) timer. In this case the cause value is rna-Update
Network-triggered
   UE receives a Paging message with a paging record matching its i-RNTI, i.e a RAN-page

There are some cases where the RRC resume procedure may be diverted, aborted or cases where a gNB may respond by not continuing with the RRC Resume procedures. These cases include:
T319 expiry
   T319 is the UE timer that puts a limit on how long a UE may perform RRC Resume
   Upon expiry the UE autonomously goes to RRC idle and lets upper layers deal with the re-connection
Receiving a RRCSetup in response to a RRCResumeRequest
   This can for instance occur if a gNB is unable to retrieve the UE context or any other errors preventing RRC Resume from being established
Receiving a RRCReject in response to a RRCResumeRequest
   Can occur when the cell is overloaded or similar. In this case the UE may remain in RRC inactive and may be configured with a waitTime (T302), whereupon expiry the UE may re-attempt RRC Resume procedures
   This example is seen in FIG. 4b, where RRCReject {waitTime} (4) (i.e. a RRCReject message including a waittime field and/or in which a waittime is configured) is sent by the gNB in response to the RRCResumeRequest (2) when the gNB determines to reject (3) the RRCResumeRequest from the UE. The UE then waits according to waitTime (T302) before making another RRCResumeRequest (5). If the another RRCResumeRequest (5) is accepted, the RRCResume+RRCResumeComplete (6) are transmitted as set out above. If the initial RRCResumeRequest (2) is accepted by the gNB, (4) and (5) may not be performed.
   In some examples, the RRCReject may not include a waitTime.
Receiving RRCRelease in response to RRCResumeRequest
   This is for instance used when the RNAU is being performed and the network swiftly sends the UE back to RRC inactive
Inability to comply with RRCResume
   In this case the UE will autonomously move to RRC idle

The messages that may be exchanged in RRC Resume procedures include at least some of “RRCResumeRequest/RRCResumeRequest1”, “RRCReject”, “RRCSetup”, “RRCResume” and “RRCResumeComplete”.

It is aim of the present disclosure to consider issues associated with controlling an NCR forwarding function in consideration of at least the events indicated above.

The above information is presented as background information only to assist with an understanding of the present disclosure. No determination has been made, and no assertion is made, as to whether any of the above might be applicable as prior art with regard to the present invention.

### DISCLOSURE OF INVENTION

### Technical Problem

The purpose of this application is to be able to solve at least one of the drawbacks of the prior art.

There is a need to derive a method and apparatus to control a forwarding function of a network controlled repeater in various communication situations.

### Solution to Problem

It is an aim of certain examples of the present disclosure to address, solve and/or mitigate, at least partly, at least one of the problems and/or disadvantages associated with the related art, for example at least one of the problems and/or disadvantages described herein. It is an aim of certain examples of the present disclosure to provide at least one advantage over the related art, for example at least one of the advantages described herein.

According to at least one embodiment of the disclosure, a method performed by a terminal in a wireless communication system is provided.

The scope of the various examples of the present invention may be determined from the independent claims. Certain embodiments are outlined in the dependent claims.

Embodiments or examples disclosed in the description and/or figures falling outside the scope of the claims are to be understood as examples useful for understanding the present invention.

In accordance with an aspect of the present disclosure, a method, of a repeater node configured to perform a forwarding function in a network, comprises: while communicably connected to a first network entity in the network, detecting a change in a link with the first network entity; and modifying the forwarding function based on detecting the change.

According to various examples, detecting the change comprises: determining a number of out of sync indications to be equal to or greater than a first predetermined number, wherein each of the out of sync indications is identified based on measurement of transmissions on the link with the first network entity.

According to various examples, the method further comprises: starting a timer; wherein the forwarding function is modified when the timer is started.

According to various examples, the method further comprises, before expiration of the timer, if a number of in sync indications is determined to be equal to or greater than a second predetermined number, stopping the timer and further modifying the forwarding function; wherein each in sync indication is identified based on transmissions on the link with the first network entity.

According to various examples, one or more of the first predetermined number, a duration of the timer, and the second predetermined number are configured to be specific to the forwarding function.

According to various examples, the method further comprises: if the timer expires, identifying radio link failure between the repeater node and the first network entity.

According to various examples, detecting the change comprises: detecting that a number of unsuccessful scheduling request attempts on the link is equal to or greater than a third predetermined number; and/or determining a reduction in scheduling resources configured for the repeater node.

According to various examples, the method further comprises: initiating random access with the first network entity in response to detecting the change; and in response to successful completion of random access, further modifying the forwarding function.

According to various examples, detecting the change comprises one of: determining an increased number of re-transmission requests; determining an occupancy threshold of a buffer of the repeater node to be exceeded; or determining low efficiency of a modulation and coding scheme.

According to various examples, detecting the change comprises one of: determining that an RRCSetup message has been received from the first network entity; or determining that an RRCReject message has been received from the first network entity.

According to various examples, the RRCSetup message and the RRCReject message are received in response to an RRCResumeRequest message transmitted by the repeater node to the first network entity.

According to various examples, modifying the forwarding function comprises changing the forwarding function from ON to OFF if the RRCReject message does not include a wait time.

According to various examples, modifying the forwarding function is performed in response to receiving an instruction from a controlling network entity.

According to various examples, detecting a condition change comprises: detecting fulfilment of a specific measurement criterion when performing a measurement event, in response to a received measurement reporting configuration by the controlling network entity, wherein the received measurement reporting configuration comprises a flag for configuration of the forwarding function in response to the measurement criteria; and modifying the forwarding function in response to the detected fulfilment of the specific measurement criterion.

According to various examples, modifying the forwarding function comprises one of: changing the forwarding function from ON to OFF; changing a configuration of the forwarding function; and if the forwarding function is OFF, further modifying the forwarding function comprising changing the forwarding function from OFF to ON.

According to another aspect of the present disclosure, there is provided a repeater node comprising: a transmitter; a receiver; and a controlled configured to: while the repeater node is communicably connected to a first network entity in the network, detect a change in a link with the first network entity; and modify the forwarding function based on detecting the change.

According to various examples, the repeater node is configured to operate according to any one or more method described above.

According to another aspect of the present disclosure, there is provided a network comprising a repeater node according to any of the aspects and examples described above.

According to another aspect of the present disclosure, there is provided a computer program comprising instructions which, when the program is executed by a computer or processor, cause the computer or processor to carry out a method according any one or more of the aspects and examples describes above.

According to another aspect of the present disclosure, there is provided a computer-readable data carrier having stored thereon a computer program according to the aspect described above.

Other aspects, advantages and salient features of the invention will become apparent to those skilled in the art from the following detailed description taken in conjunction with the accompanying drawings.

### Advantageous Effects of Invention

Embodiments of the present disclosure provides methods and apparatus for controlling a forwarding function of a network controlled repeater in various communication situations.

### BRIEF DESCRIPTION OF DRAWINGS

FIG. 1 illustrates network architecture of NCR communication according to various examples of the present disclosure;

FIG. 2a illustrates Radio Link Failure (RLF) by a UE in response to a triggered timer;

FIG. 2b illustrates a recover condition for a UE during the timer duration;

FIG. 3 illustrates re-establishment procedure for a UE after RLF;

FIG. 4 illustrates failure indication procedure (RLF and RRC re-establishment), and RLF Report transmission;

FIG. 4b illustrates a UE being rejected when attempting to move to RRC connected mode from RRC inactive via an RRC Resume procedure;

FIGS. 5a and 5b are diagrams for modifying the forwarding function according to various examples of the present disclosure;

FIG. 6 is a diagram for modifying the forwarding function according to various examples of the present disclosure;

FIG. 7 is a diagram for modifying the forwarding function in response to a measurement event condition according to various examples of the present disclosure;

FIGS. 8a and 8b are diagrams for modifying the forwarding function following Radio Link Failure according to various examples of the present disclosure;

FIG. 9 is a diagram for modifying the forwarding function following Radio Link Failure according to various examples of the present disclosure;

FIGS. 10a-c are diagrams for modifying the forwarding function following Radio Link Failure according to various examples of the present disclosure;

FIGS. 11a and 11b are diagrams for modifying the forwarding function during handover according to various examples of the present disclosure;

FIG. 11c is a diagram illustrating turning off NCR-Fwd when receiving an RRCSetup in response to an RRCResumeRequest according to an example of the present disclosure;

FIG. 11d is a diagram illustrating NCR-Fwd remaining on while an RRCReject with waitTime is received in response to an RRCResumeRequest, and turning off NCR-Fwd when receiving RRCReject without a waitTime in response to an RRCRe-sumeRequest according to an example of the present disclosure.

FIG. 12 is a block diagram of an exemplary network entity that may be used in certain examples of the present disclosure.

### MODE FOR THE INVENTION

The following description of examples of the present disclosure, with reference to the accompanying drawings, is provided to assist in a comprehensive understanding of the present invention, as defined by the claims. The description includes various specific details to assist in that understanding but these are to be regarded as merely exemplary. Accordingly, those of ordinary skill in the art will recognize that various changes and modifications of the examples described herein can be made without departing from the scope of the invention.

The same or similar components may be designated by the same or similar reference numerals, although they may be illustrated in different drawings.

Detailed descriptions of techniques, structures, constructions, functions or processes known in the art may be omitted for clarity and conciseness, and to avoid obscuring the subject matter of the present invention.

The terms and words used herein are not limited to the bibliographical or standard meanings, but, are merely used to enable a clear and consistent understanding of the invention.

Throughout the description and claims of this specification, the words “comprise”, “include” and “contain” and variations of the words, for example “comprising” and “comprises”, means “including but not limited to”, and is not intended to (and does not) exclude other features, elements, components, integers, steps, processes, operations, functions, characteristics, properties and/or groups thereof.

Throughout the description and claims of this specification, the singular form, for example “a”, “an” and “the”, encompasses the plural unless the context otherwise requires. For example, reference to “an object” includes reference to one or more of such objects. Throughout the description and claims of this specification, language in the general form of “X for Y” (where Y is some action, process, operation, function, activity or step and X is some means for carrying out that action, process, operation, function, activity or step) encompasses means X adapted, configured or arranged specifically, but not necessarily exclusively, to do Y.

Features, elements, components, integers, steps, processes, operations, functions, characteristics, properties and/or groups thereof described or disclosed in conjunction with a particular aspect, embodiment, example or claim are to be understood to be applicable to any other aspect, embodiment, example or claim described herein unless in-compatible therewith.

The skilled person will appreciate that the techniques described herein may be used in any suitable combination.

Certain examples of the present disclosure provide methods, apparatus and systems for performing a forwarding function in a network. For example, certain examples of the present disclosure provide methods, apparatus and systems for performing forwarding in a 3GPP 5G NR network including an NCR. However, the skilled person will appreciate that the present invention is not limited to these examples, and may be applied in any suitable system or standard, for example one or more existing and/or future generation wireless communication systems or standards, including any existing or future releases of the same standards specification, for example 3GPP 5G.

The following examples are applicable to, and use terminology associated with, 3GPP 5G. However, the skilled person will appreciate that the techniques disclosed herein are not limited to 3GPP 5G. For example, the functionality of the various network entities and other features disclosed herein may be applied to corresponding or equivalent entities or features in other communication systems or standards. Corresponding or equivalent entities or features may be regarded as entities or features that perform the same or similar role, function or purpose within the network.

A particular network entity may be implemented as a network element on a dedicated hardware, as a software instance running on a dedicated hardware, and/or as a vir-tualised function instantiated on an appropriate platform, e.g., on a cloud infrastructure.

The skilled person will appreciate that the present invention is not limited to the specific examples disclosed herein. For example:
The techniques disclosed herein are not limited to 3GPP 5G.
One or more entities in the examples disclosed herein may be replaced with one or more alternative entities performing equivalent or corresponding functions, processes or operations.
One or more of the messages in the examples disclosed herein may be replaced with one or more alternative messages, signals or other type of information carriers that communicate equivalent or corresponding information.
One or more further elements, entities and/or messages may be added to the examples disclosed herein.
One or more non-essential elements, entities and/or messages may be omitted in certain examples.
The functions, processes or operations of a particular entity in one example may be divided between two or more separate entities in an alternative example.
The functions, processes or operations of two or more separate entities in one example may be performed by a single entity in an alternative example.
Information carried by a particular message in one example may be carried by two or more separate messages in an alternative example.
Information carried by two or more separate messages in one example may be carried by a single message in an alternative example.
The order in which operations are performed may be modified, if possible, in al-ternative examples.
The transmission of information between network entities is not limited to the specific form, type and/or order of messages described in relation to the examples disclosed herein.

Certain examples of the present disclosure may be provided in the form of an apparatus/device/network entity configured to perform one or more defined network functions and/or a method therefor. Certain examples of the present disclosure may be provided in the form of a system (e.g. network or wireless communication system) comprising one or more such apparatuses/devices/network entities, and/or a method therefor. Certain examples as described below may refer to an NCR; however, it will be appreciated that this is an example of a repeater node, and the examples described below are also applicable to a case of a repeater node. Certain examples as described below may refer to a gNB; however, it will be appreciated that this is an example of a network entity or base station, and the examples described below are also applicable to a case of a network entity or base station,

In relation to the operation of NCR-Fwd, 3GPP have agreed or proposed that:

### 3GPP Meeting RAN2 #120

On NCR-Fwd ON/OFF:
   When NCR-MT is in RRC_CONNECTED mode, the NCR-Fwd can be ON or OFF following the side control information received from the gNB.
   After NCR-MT enters RRC_INACTIVE mode, the NCR-Fwd can be ON or OFF following the last configuration received from the gNB.
   Release to RRC-IDLE is FFS.
On NCR-MT RLF:
   After RLF is declared by NCR-MT, NCR-MT performs cell selection and trigger RRC re-establishment;
   If NCR-MT enters RRC_IDLE due to no suitable cell is find, NCR-Fwd is OFF;
   During RRC re-establishment procedure, NCR-Fwd is OFF.

### 3GPP Meeting RAN2 #121

### Agreements:

The NCR-FWD is switched OFF if the NCR-MT in RRC_INACTIVE state reselects a different cell than the last serving cell on which side control configuration was received.
After cell reselection, the NCR-MT to resume so that it can receive side-control configuration from the new gNB (can be done by network configuration using existing specifications). The case when a NCR-MT goes to an acceptable cell and comes back and the case when no cell found are FFS.

### 3GPP Meeting RAN1 #112

Once beam failure is detected in C link by NCR-MT, NCR-Fwd is OFF until the beam failure recovery is completed.

The general principle of the above agreements and reasoning for controlling the NCR-Fwd is that NCR-Fwd should not be turned ON when the network does not have sufficient control of the NCR or when NCR-Fwd may cause interference due to its forwarding behaviour. Thus the above agreements are that NCR-Fwd should be OFF during the RLF procedures, as the donor gNB will not have sufficient control of the NCR and that the NCR-Fwd should be switched OFF when the NCR-MT selects another cell.

However, further to the above, there are several cases when the network (e.g. network entity) may not be in control, or may start to lose control of the NCR. In such cases, there is a need to consider the operation of NCR-Fwd, which may be turned ON, for the reasons indicated above. In addition, there is also the need to consider whether NCR-Fwd should be turned ON (i.e. after being turned OFF), for example, in response to RRC re-establishment following Radio Link Failure.

Various examples of the present disclosure provide methods, apparatus, or systems etc. which address, mitigate or consider such issues.

With reference to the present disclosure, the NCR-Fwd of the NCR (i.e., a forwarding function of a repeater node) will be defined as either ON or OFF; i.e., operating, or configured to operate, in either an ON state or an OFF state. In various examples, an ON state of the NCR is intended to define a state of forwarding (e.g., based on configuration information associated with a cell or gNB), or being configured to perform a forwarding function for, signals between a base station (e.g. gNB) to a target UE. In some examples, when operating in the ON state, the NCR-Fwd may forward all signals from the gNB to the UE. In some examples, it may forward only selected signals. Information on selected signals to forward may be received via signalling, or instruction from a network entity etc. In another example, based on a connected donor gNB, the NCR may forward the full bandwidth of the donor gNB, which is known from knowing what frequencies the donor gNB operates on. In some examples, the NCR-Fwd operating in the ON state may be configured to forward signals received on specific transmissions from the gNB; and/or forward signals to the UE on specific transmissions generated by the NCR-Fwd. These transmissions may be one or more beams, for example, each having one or more allocated SIB index. In other examples, the specific transmissions may refer to a set of allocated SIB indices.

Similarly, in various examples of the present disclosure, where NCR-Fwd is described as being OFF, or in an OFF state, this defines a state of the NCR not forwarding, or not currently being configured to perform a forwarding function, for signals between a base station (e.g. gNB, such as a gNB controlling a cell the NCR camped on previously) and a target UE. In some examples, the NCR-FWD is turned off, such that it is not configured to, and/or does not provide, any forwarding of signals to the UE, and/or does not perform any forwarding of signals from the UE to the gNB. In some examples, the NCR-Fwd in an OFF state refers to any state or configuration related to NCR-Fwd being in an off state. In some examples, the NCR-Fwd being in an OFF state indicates that NCR-Fwd does not perform, or stops performing, forwarding using a configuration (e.g., configuration information) associated with a cell the NCR camped on previously (e.g., prior to cell reselection). In some examples, the NCR-Fwd being in an OFF state indicates that the NCR-Fwd does not perform, or stops performing, forwarding for a cell (or a base station, e.g., gNB) on which the NCR camped previously (e.g., prior to cell reselection). The NCR-Fwd being in an OFF state may indicate that the NCR-Fwd does not forward anything, or that the forwarding configuration is discarded (e.g., such that a new forwarding configuration/new configuration information is used) and/or a default forwarding configuration is applied. In some examples, NCR-Fwd being in an OFF state or turned OFF may indicate that the forwarding is modified to be performed differently to previous forwarding (e.g., based on different configuration information). For example, said forwarding configuration may refer to beam information, which indicates slot and/or indices information, for signal transmission.

### Controlling NCR-Fwd During Failures

In various examples, NCR-Fwd may be turned OFF (from being configured in an initial ON state) if the NCR (i.e., NCR-MT) detects problems or anomalies in the physical layer (for example, during RRC_Connected). That is, for example, the NCR-MT may detect one or more condition changes associated with the control link to the gNB.

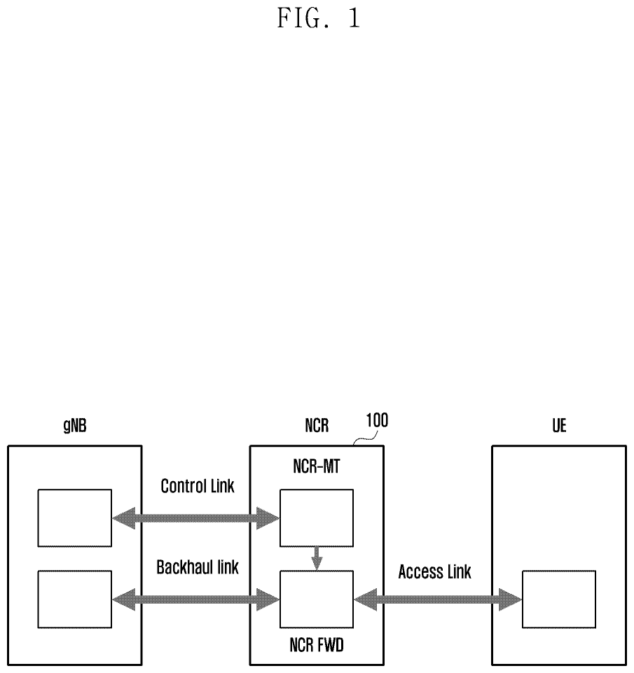

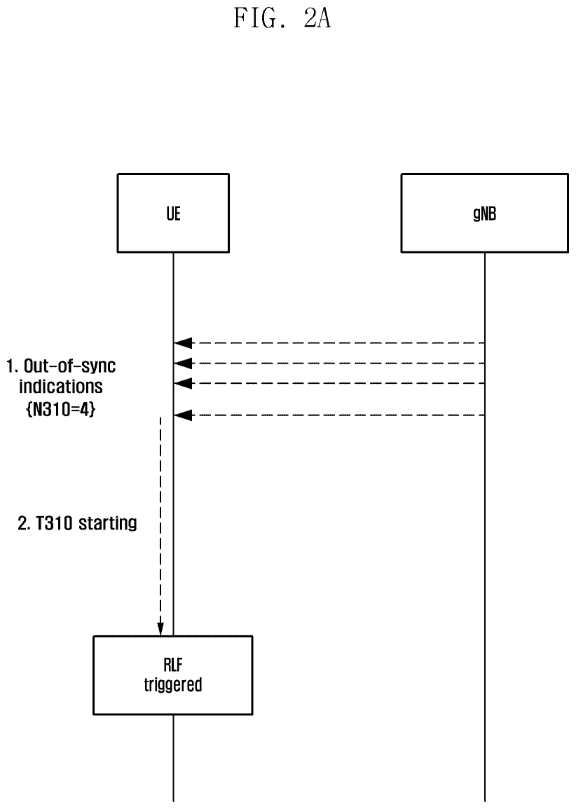

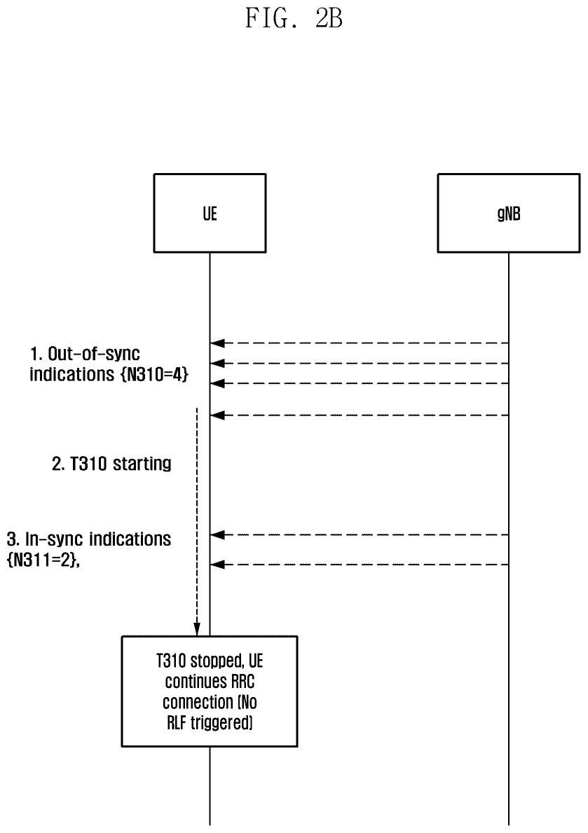

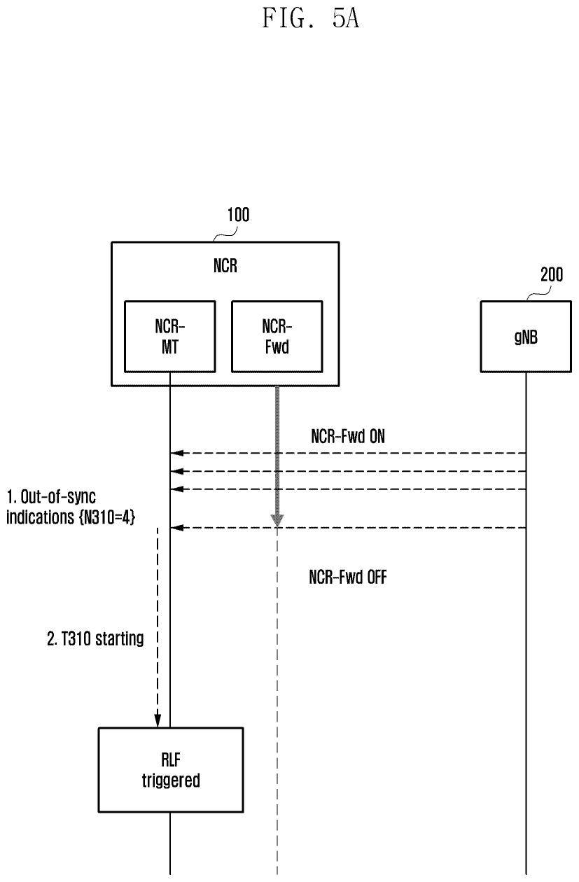

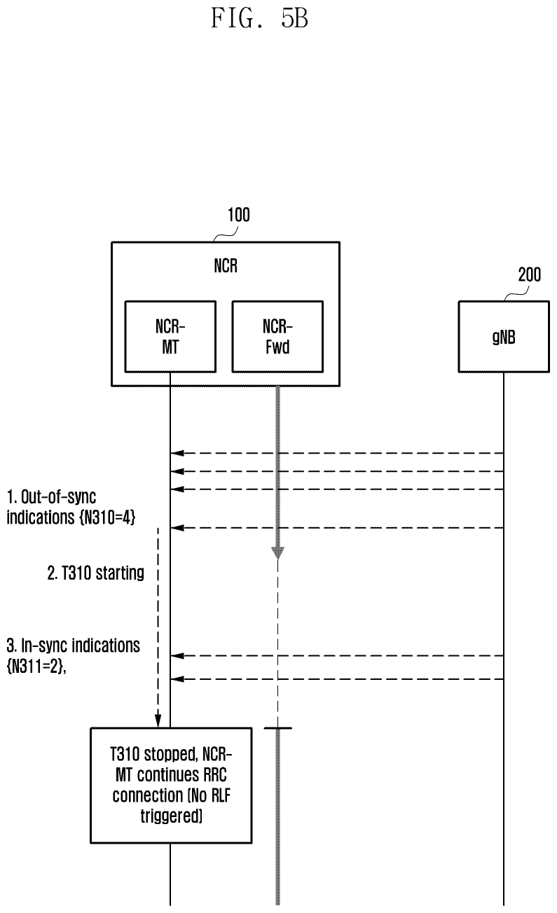

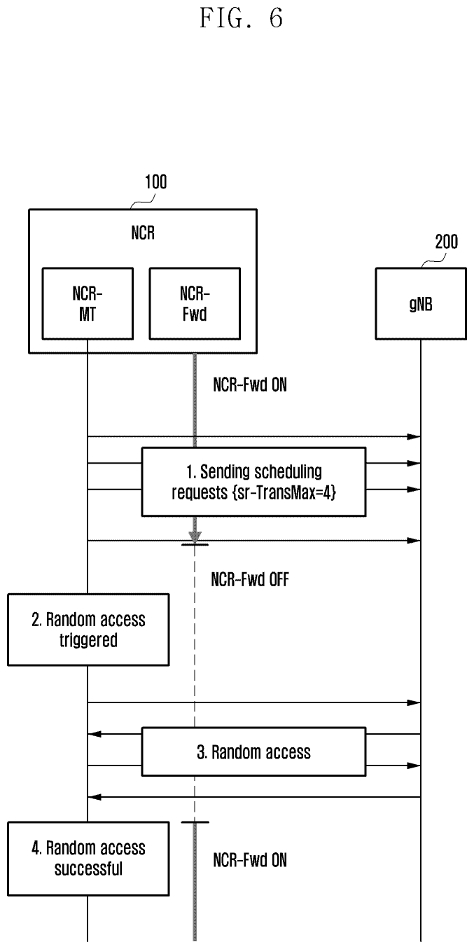

In an example, such as described with relation to FIGS. 5a and 5b, the detected one or more changes (or problems, or anomalies) may be determined from a number of out-of-sync indications (e.g., arising or deriving from reduced cell strength). Referring to FIGS. 5a and 5b, it will be seen that these diagrams corresponds to the diagrams of FIGS. 2a-2b, now described with reference to a repeater node (e.g., NCR 100, such as described with reference to FIG. 1). Herein, the NCR 100 may initially be commu-nicating with or communicably connected to a base station (e.g. gNB 200), or camping on a cell of the network controlled by the base station, and the NCR 100 may initially be performing a forwarding function (e.g., via NCR-Fwd to a UE).

Referring to FIG. 5a, the NCR 100 (e.g. NCR-MT) may measure (or monitor) the cell strength through measurement of one or more transmissions with gNB 200 (i.e. through radio link monitoring). When cell strength is determined to be below a certain threshold (or when cell strength is reduced) a number of times this may result in a cor-responding number (i.e. a first pre-determined number) of out-of-sync indications, where such indications are received from lower layers of a protocol stack of NCR-MT (e.g., in general, NCR may identify an out of sync indication based on a measurement result being below a threshold and, if a number of out of sync indications is greater than or equal to a predetermined number, the timer (T310) is started). In an example, this number, N310, is 4. N310 may be defined as threshold number of indications before the timer T310 is started. Therefore, when this threshold is reached, the NCR-MT triggers a timer (T310) for the NCR 100 to recover, wherein, if the timer duration (or expiry of the timer) is reached, RLF is triggered. Initially, NCR-Fwd is ON (that is, the NCR 100 is providing a forwarding function). However, if the threshold (N310) is reached (e.g., the number of out of sync indications equals or exceeds the prede-termined number), NCR-Fwd is modified, e.g., turned off. In other words, the threshold being reached triggers both NCR-Fwd to be turned OFF, and timer T310 to be started. Alternatively, it may be seen than NCR-Fwd is turned off for at least the duration of the timer (T310). An example of how this may be represented in a specification (e.g., technical specification) can be seen in Specification Example 1 (see Annex).

It will be appreciated that, whilst, conventionally, triggering of RLF may itself trigger NCR (e.g. NCR 100) to turn OFF NCR-Fwd, problems arising due to the out-of-sync indications may arise prior to RLF, such as significant interference in the network if NCR-Fwd remains on (i.e. NCR-Fwd continues forwarding whilst NCR-MT is out of sync). Examples of the present disclosure therefore mitigate or prevent this issue.

Referring now to FIG. 5b, a recovery condition following starting of timer T310 is described, with reference to an NCR 100. Similarly to FIG. 5a, when the number of out of sync indications (i.e. from lower layers) (N310) has been reached, NCR-Fwd is turned off, and timer T310 is started. Once the timer has started, an in-sync in-dication(s) may be received (e.g., from lower layer(s)) or identified (e.g., based on transmission(s) from the gNB) of a pre-configurable number (i.e. a second prede-termined number) of times (N311). In an example, this number, N311, may be 2. If this number of indications is reached, the timer T310 is stopped. In some examples, when the timer T310 is stopped, NCR-Fwd may be modified, e.g., turned ON (or resumed). In other words, a threshold of in-sync indications (N311) may trigger the stopping of the timer, and the change of NCR-Fwd to ON (i.e. it will continue, or resume, forwarding). No RLF may be triggered if the timer is stopped (i.e., if the number of in sync indications is equal to or greater than the threshold or pre-configurable number).

In a further example, the numbers (values) of N310, N311 and T310 may be specifically configured to indicate when NCR-Fwd should be modified (i.e. turned from ON to OFF). For example, these numbers may be configured to be different from the numbers used to trigger RLF, and in some examples, these may be smaller (i.e. such that an NCR specific T310 value will trigger NCR-Fwd to off, but not RLF). In these examples, this would provide that NCR-Fwd is turned off when the NCR-MT control link is poor, but RLF is not, or has not yet been, triggered.

In an example, when detecting problems, or anomalies, changes, as described above, the NCR-MT may control the forwarding function to fall back to another (or default) forwarding configuration. That is, the NCR-MT may change, or control to change, the configuration of NCR-Fwd to perform the forwarding function when said problems are detected (e.g., during Radio Link Monitoring). In an example, the forwarding configuration can be simplified from the current forwarding configuration, such as to allow for less interference. Examples may include changing beam configuration (e.g. from specific beam configurations, where concentrated beams can cause inter-cell in-terference, to a wider beam configuration), or to reduce the amount of forwarding performed by NCR-Fwd. Such fall back configurations (or NCR-Fwd default config-urations) can be hard-coded, preconfigured, or dynamically signalled/modified by a network (e.g. by a network entity). In addition, in some examples, these fall back configurations can be used for different problems, anomalies, or changes. In other words, in dependence on the problem or change detected, the NCR-MT may control to change to a specific NCR-Fwd configuration as described.

In another example, a problem may arise if the NCR-MT is unable to deliver uplink data. This may arise in a number of cases, for example, when the NCR-MT is unable to get/acquire uplink resources. This may occur, or may be determined, when the number of Scheduling Request attempts (e.g., by NCR-MT) are equal to or greater than a threshold number, or there are no Scheduling Request resources configured. In such cases, random access may be performed to regain resources. Therefore, NCR-Fwd may be turned OFF when there are no uplink resources or insufficient (e.g., below a threshold number) uplink resources. An example of how this may be represented in a specification (e.g., technical specification) can be seen in Specification Example 2 (see Annex). After having re-gained sync after successful random access procedure, the NCR-Fwd may be turned ON again. This is described with reference to FIG. 6.

Referring to FIG. 6, the NCR 100 may initially be communicating with (or camped on a cell of) a base station (e.g. gNB 200), and the NCR 100 may initially be performing a forwarding function (e.g., via NCR-Fwd to a UE). At step 1. the NCR-MT performs a number of scheduling request attempts until a pre-configured threshold, or a maximum number, (which may be termed a third predetermined number) of scheduling request attempts, is reached. In the example shown, this number may be 4 (sr-TransMax=4). Once this threshold has been reached, the NCR-MT may configure to turn off NCR-Fwd, and random access may be triggered (Step 2). In other words, NCR-Fwd is OFF whilst random access is performed (step 3). On completion of successful random access procedure (i.e. re-gained synchronisation), NCR-Fwd may be turned on (i.e. the NCR may continue to perform forwarding).

In further examples, NCR-Fwd may be autonomously turned off (i.e. pre-configured to be turned off) when other problems or anomalies arise, or are detected, on the control link, such as one or more of:
Increased number of re-transmission requests;
   This can for instance be RLC PDUs or HARQ (Transport Blocks) that are re-transmitted more than a certain number of times. For example, if a number of NACK (negative acknowledgement) sent from the NCR to the gNB to request re-transmission (e.g. due to an error being detected through HARQ) is equal to or more than a prede-termined number, NCR-Fwd may be turned off. In another example, if a number of NACK sent from NCR to gNB following unsuccessful receipt (e.g. due to error detection) of an RLC packet (E.g. RLC PDU) is equal to or greater than a prede-termined number, NCR-Fwd may be turned off.
Buffers reaching a certain occupancy threshold;
   This can be done by measuring the buffers on for instance MAC level and seeing that they are too high.
Modulation & coding schemes that are being employed with too low rates;
   This shows that the control link is very poor, indicating that the Forwarding operation is not likely to bring a lot of benefits for the network (forwarding also amplifies noise, causing low SNR if the received signal from gNB is very low).

In an example, the gNB may instruct NCR-Fwd to turn off forwarding, for example, via dedicated signalling to NCR-MT. This instruction may be in response to deter-mination (e.g. based on received Buffer Status Reports from the NCR-MT and/or UEs connecting via NCR, or various reference signals) that the gNB cannot allocate the needed resources and/or provide the needed QoS to the NCR device on one or more of control, access and backhaul links.

In another example, NCR-Fwd may be modified based on measurement criteria. In an example, measurement reports may be set up to trigger modification of the forwarding function (e.g. to turn NCR-Fwd to off), based on specific measurement criteria. In an example, a flag may be configured in a measurement report wherein, if an event condition is true (i.e. an event condition is fulfilled during measurement by the NCR), the NCR (e.g. NCR 100) is configured to turn OFF NCR-Fwd. This can be beneficial to allow for more proactive switching of NCR-Fwd to off, e.g. when NCR is handed over to another cell.

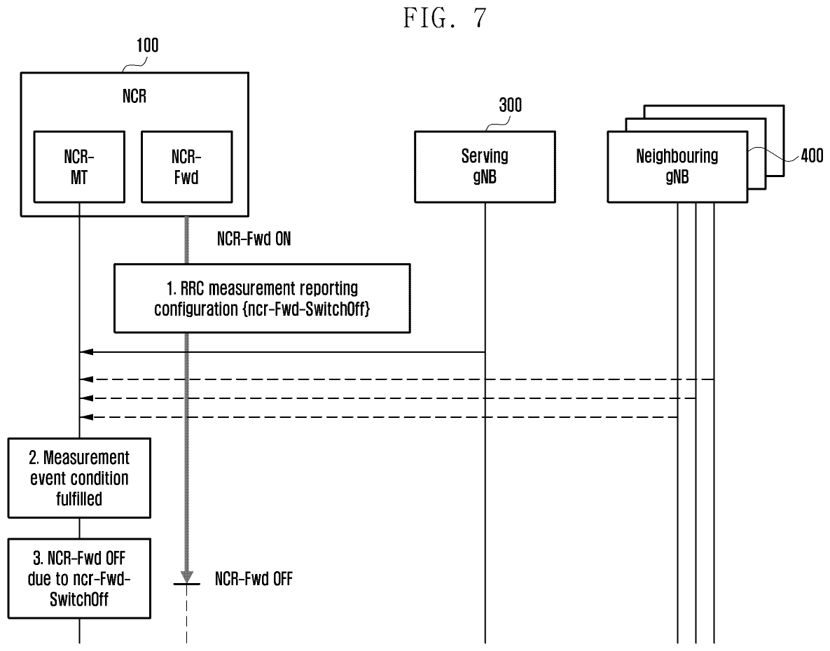

In an example, a gNB (e.g. donor gNB) configures the NCR-MT with a measurement event (A3) that compares the serving cell signal strength to neighbouring cell signal strengths and triggers if the neighbour cell signal strength is larger than a threshold. Thus the NCR-MT will measure serving and neighbour cell signal strength and if the neighbouring cell signal strength exceeds the threshold, the NCR-Fwd will be turned OFF and then a measurement report is sent. This example can be seen in FIG. 7, and an example of how this may be represented in a specification (e.g., technical specification) can be seen in Specification Example 3 (see Annex).

Referring to FIG. 7, the NCR 100 may initially be communicating with a base station (e.g. serving gNB 300, which may be the same or different to gNB 200), and the NCR 100 may be performing a forwarding function (e.g. forwarding on a cell controlled by the serving gNB 300 via NCR-Fwd to a UE), i.e. NCR-Fwd is on. In this example, a serving gNB 200 (e.g. donor gNB), configures the NCR-MT with a measurement event (step 1, RRC measurement reporting configuration). This event may include a configured flag in relation to NCR-Fwd modification (“ncr-Fwd-Switchoff”). In response to the received measurement configuration, the NCR-MT will measure serving and neighbouring cell signal strength, and if the neighbouring cell signal strength exceeds a threshold (i.e. it is determined that the event condition is met on completion of the measurement, Step 2), NCR-Fwd is turned OFF (Step 3), and a measurement report may be sent. Accordingly, in some examples, the NCR may determine that a handover (e.g., to a neighbouring cell (e.g. as controlled by neighbouring gNB 400) with cell signal strength exceeding the threshold) is imminent, and may pro-actively turn off NCR-Fwd as a result.

In a further example, the donor gNB configures the NCR-MT to measure neighbour cell UE signal strengths. The event condition in this example may relate to the signal strengths of the neighbour cell UE, with fulfilment of the condition resulting in NCR-Fwd being turned OFF (for example, in view of the flag being configured in the measurement configuration from the donor gNB).

### Controlling NCR-Fwd During Connection (Re-)Establishment

The following examples describe modifying the NCR-Fwd function (i.e. modifying NCR-Fwd from OFF to ON) during RRC re-establishment (for example, following Radio Link Failure). It will be appreciated that any of the following examples may be combined with any of those described previously. For instance, an example in the previous section may describe turning the forwarding function OFF upon detecting a condition to be met or a trigger (e.g., impending RLF, a number of out of sync indications being received, etc.), and such may be combined with an example from this section in which the forwarding function is turned ON upon detecting another condition to be met or another trigger (e.g., RRC reestablishment being complete or received by the NCR, receiving an instruction from a network entity, etc.).

In examples described below, specific RRC messages may be referred to. It will be appreciated that reference may instead be made, more generally, to an RRC message (e.g., first RRC message, second RRC message, etc.), to an RRC request (e.g., first RRC request, second RRC request etc.), or to an RRC response (e.g.,, first RRC response, second RRC response etc.). The present disclosure is not limited to the specific RRC messages referred to below.

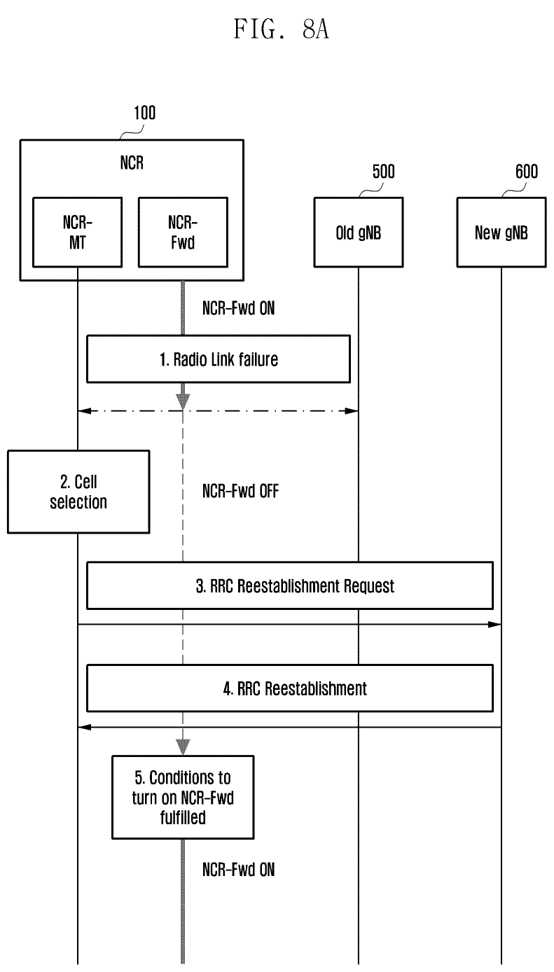

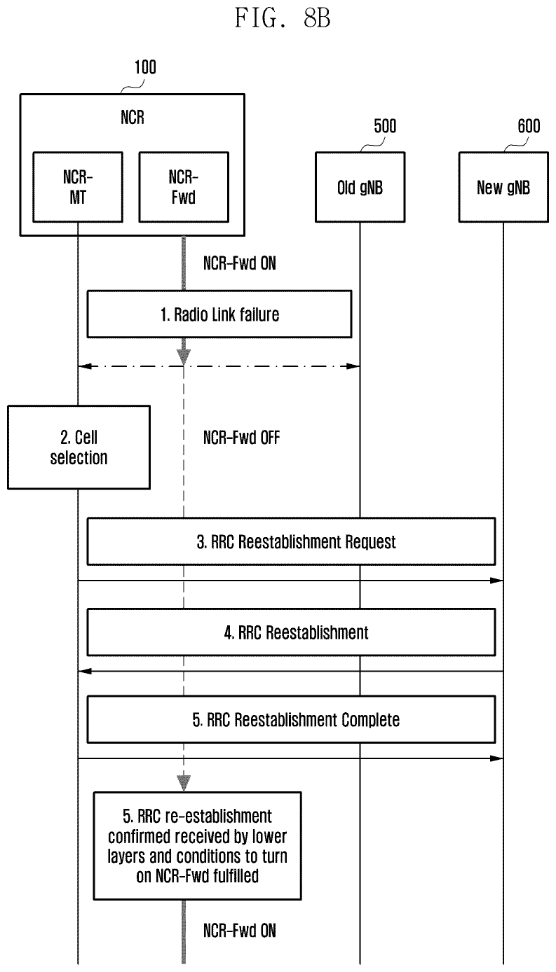

Referring to FIG. 8a, a forwarding function (NCR-Fwd) of an NCR 100 may be turned from ON to OFF following Radio Link Failure (step 1). It will be appreciated that, in certain examples, this may follow a procedure such as described in relation to FIG. 5 where RLF occurs, or any other example where RLF occurs. The NCR 100 (i.e. NCR-MT) performs cell selection (at step 2) to determine (or identify, or select, or find etc.) a new cell (which may, in some examples, be the same cell as the NCR 100 camped on when forwarding was performed (i.e. NCR-Fwd turned on)), and (re-) connects to the determined cell. In the example shown in FIG. 8a, the NCR-MT transmits RRCReestablishment Request (step 3) to a gNB 600 controlling the de-termined cell (which may be a new gNB 600 or the same gNB 500 as controlled the cell on which NCR camped when forwarding was performed (NCR-Fwd ON)), and in response, receives RRCReestablishment from the new gNB 600 (step 4). In response to receiving RRCReestablishment, the NCR-MT may modify NCR-Fwd to ON. In some examples, turning or modifying NCR-Fwd to ON may be performed in response to fulfilling a number of conditions (Step 5).

Referring to one or more of the examples described, said conditions to be met for turning NCR-Fwd ON (e.g., following Radio Link Failure, and/or during/after RRC re-establishment), may comprise at least one of:
If the NCR-MT establishes on the same cell, the NCR-Fwd is turned ON, and if the NCR-Fwd does not establish to the same cell, the NCR-Fwd is kept OFF.
If the NCR-Fwd belongs to the same RAN Area Code (RANAC) as the previous cell. This can beneficial if for instance NCR-Fwd configuration is the same or similar in all cells in a RANAC.
That the RRC re-establishment procedure was not triggered by a failure in applying the NCR forwarding configuration.
   In some cases the re-establishment procedure can be triggered if a UE is unable to apply some of the NCR forwarding configuration.
There is an NCR forwarding configuration existing before the RRC re-establishment is triggered
   In some cases due to a set of failures, an NCR forwarding configuration may not have been established before an re-establishment is triggered. For instance if an NCR has connected but failed to receive an NCR configuration before the RLF is triggered.
   It can for instance be such that if the NCR forwarding configuration is less than a certain age, i.e. that if the NCR forwarding configuration is older than a threshold, then the NCR-Fwd should not be turned ON. This can be configured or hardcoded. As an example, if the configuration is less than 1 hour old, the NCR-Fwd is not turned ON.

In another example, as shown in FIG. 8b, NCR-Fwd may be turned on following (or triggered by) transmittal to, and/or receipt of, RRCReestablishmentComplete message at the gNB (e.g. new gNB 600). For example, NCR-MT may be aware of reception of msg5 (RRCReestablishmentComplete) via lower layer acknowl-edgement(s).

Herein, steps 1-4 of FIG. 8b correspond to those of FIG. 8a. However, alter-natively to NCR-Fwd being turned on in response to receiving RRCReestablishment from the gNB 600 (step 4 of FIG. 8a); in the example of FIG. 8b, NCR-Fwd may be turned on following RRCReestablishment Complete being transmitted to and/or received by the gNB 600. The NCR-MT will be aware of the successful delivery of RRCReestablishmentComplete message through receiving lower layer (e.g., via HARQ, RLC or PDCP) acknowledgements. In some examples, turning on of NCR-Fwd may additionally have a at least one of a number of conditions (Step 5) to be met, or fulfilled, before the NCR-Fwd is turned ON, for example, with reference to the conditions set out above in relation to FIG. 8a.

In another example, it may be configurable whether the NCR (e.g. NCR 100) turns on NCR-Fwd after RRCReestablishment. Some examples of this are described below.

In an example, a flag in RRCReestablishment (i.e., received by NCR 100 from gNB) may indicate whether NCR-Fwd should be turned ON, e.g. flag ncr-Fwd-On. This can for instance be useful in a number of ways:
This includes when the NCR-MT establishes with a new cell and the new (donor) gNB is able to acquire the previous NCR configuration during the Re-establishment procedure.
When a NCR failure occurs, there could be a need to re-configure the NCR-Fwd before turning it ON. By explicitly configuring ON instead of automatically turning ON once RRCReestablishment is successfully received, there can be more flexibility.

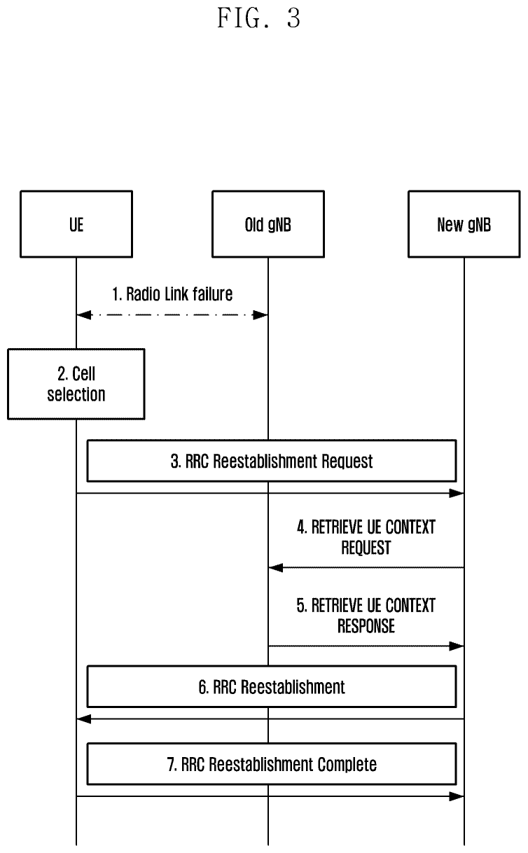

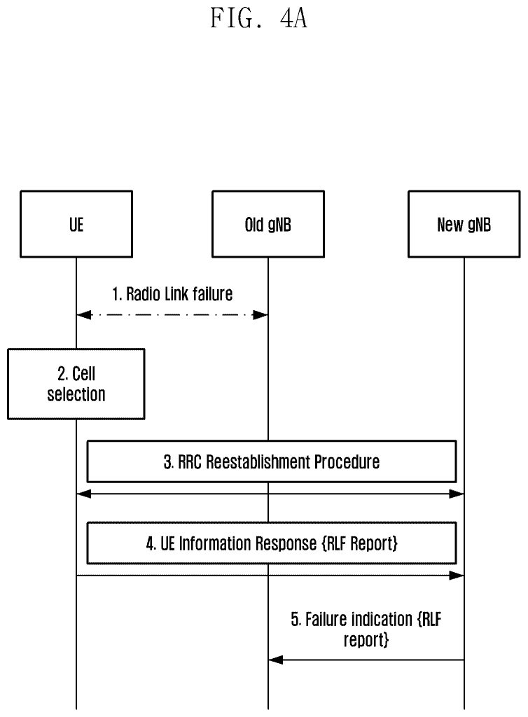

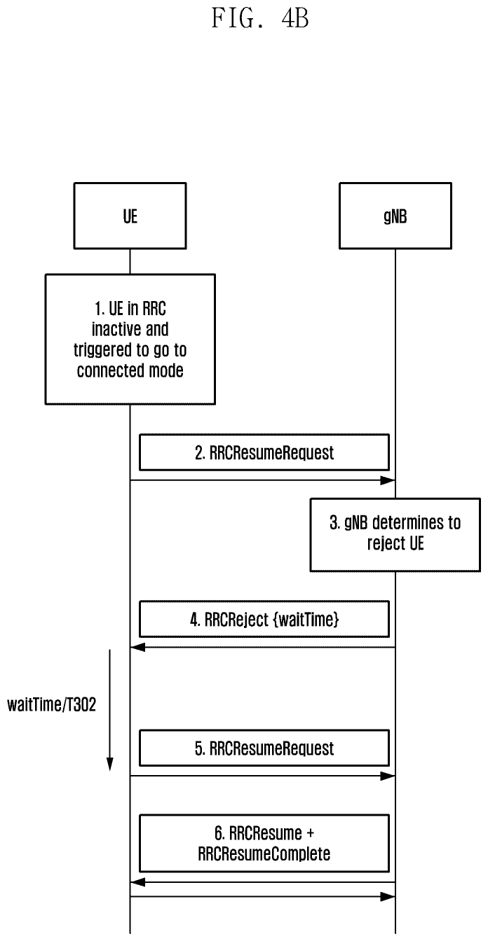

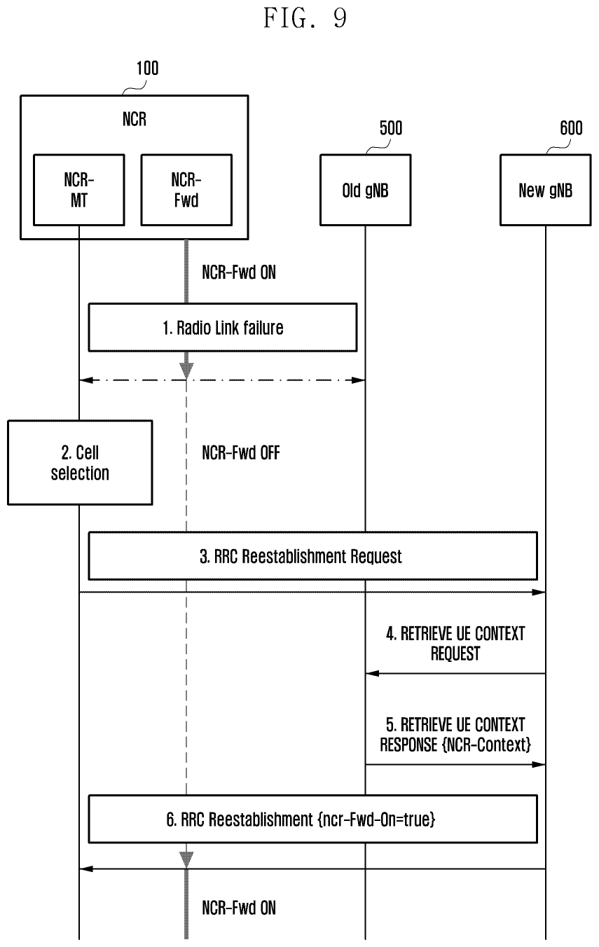

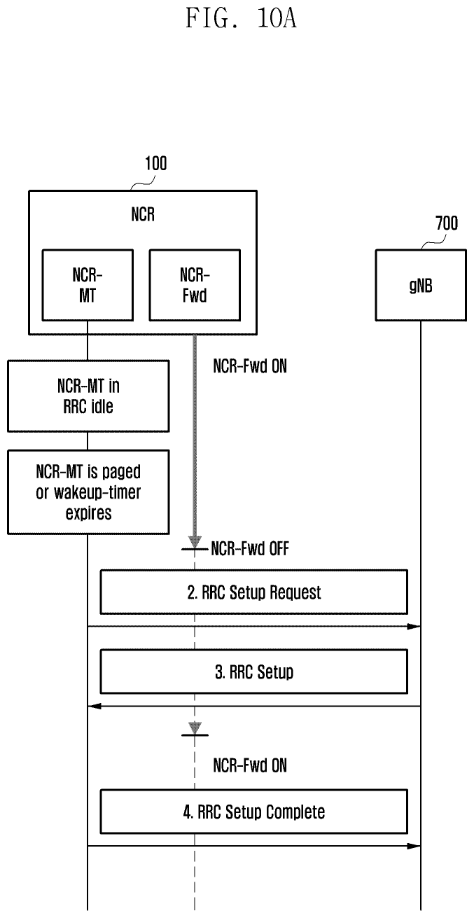

The above example is illustrated with reference to FIG. 9, where, following cell selection (step 2), the NCR 100 has selected (camped on) a new cell (i.e. as controlled by a new gNB 600). Following receipt of the RRC Reestablishment Request message (Step 3), the new gNB 600 transmits a (NCR) Context Request to the old gNB 500 of the cell on which the NCR was previously camped (Step 4), and receives a response (step 5) indicating NCR Context (i.e. comprising NCR-Context flag, or indication, such as NCR-Context). In the example shown, the request for context information of the NCR is performed using UE context message (as also shown in FIG. 3), e.g., UE Context Request and UE Context Response may be used (e.g., modified) to provide new gNB 600 with NCR context. The NCR Context may indicate a previous NCR configuration used (i.e. for NCR-Fwd). New gNB 600 transmits RRC Reestablishment message with the flag (or indication) to turn NCR-Fwd ON (ncr-Fwd-on=true), and NCR-Fwd may be turned on when received at the NCR 100. In certain examples, if the NCR selects to camp on another cell controlled by the gNB on which the NCR 100 was previously camped, e.g. gNB 500, it may be considered that the “new gNB” is actually the “old gNB”. In other examples, the cell selected to camp on following RLF is actually the cell on which the NCR was previously camped (i.e., the “new gNB” and the “old gNB” shown separately in FIG. 9 actually refer to the same network entity (gNB)). An example of how this may be represented in a specification (e.g., technical specification) can be seen in Specification Example 4 (see Annex).

In another example, a broadcasted flag in SIB1 may indicate whether the NCR (e.g. NCR 100) shall turn on NCR-Fwd after successful re-establishment or not.

In another example, a dedicated pre-configuration may indicate whether the NCR (e.g. NCR 100) shall turn on NCR-Fwd after successful re-establishment or not.

In another example, it may arise that the NCR-MT is paged, or NCR-MT is resuming (i.e. RRC Resume) to a gNB (e.g., a donor gNB) while forwarding (i.e. NCR-Fwd is on) in RRC idle or RRC inactive. Conventionally, the NCR-MT may have to turn OFF NCR-Fwd while connecting. However, a question arises as to when an NCR shall continue forwarding in this case (i.e. NCR-Fwd being turned ON). This is important as the NCR may only be paged to perform some type of update, or the NCR-MT might be instructed to re-connect to the donor gNB periodically, or after a timer.

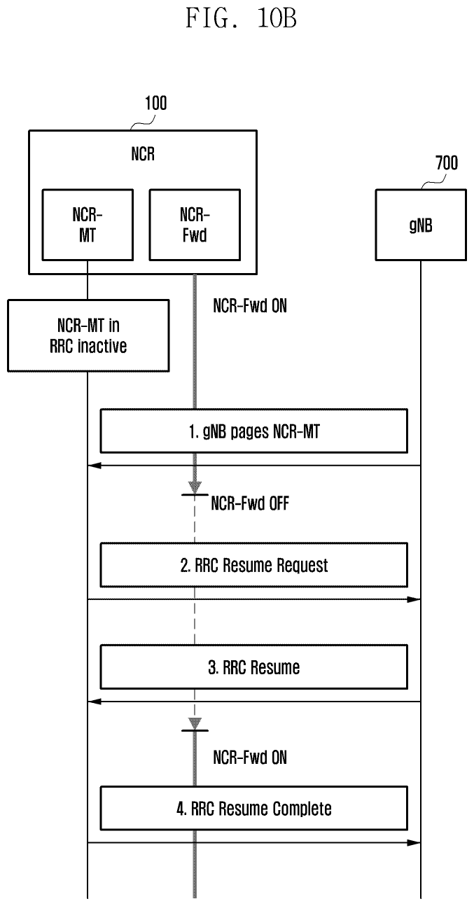

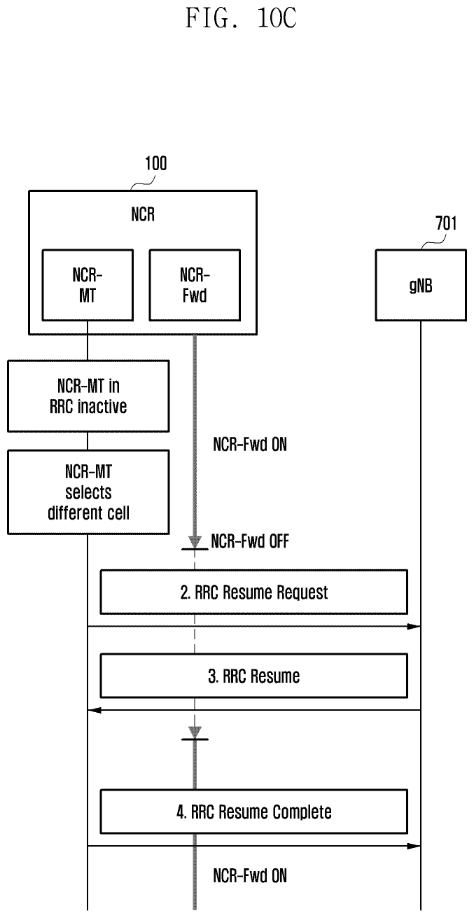

In an example, when the NCR-MT performs RRC Resume or RRC connection estab-lishment, the NCR (e.g. NCR 100) resumes NCR forwarding when the NCR-MT suc-cessfully receives the message responding to the RRC establishment (or RRC Resume) request. This message can be RRCResume or RRCSetup in this case. Similarly to the above embodiments on RRC Re-establishment (i.e. as set out with reference to FIG. 8a), NCR-Fwd may be turned ON in response to fulfilling one or more of these conditions, and/or may also be signalled using a flag in respective message(s). This is described with reference to FIG. 10.

Referring to FIG. 10a, the NCR 100 (i.e. NCR-MT) is in RRC Idle (e.g., is in a standby state and is not assigned to a serving base station). In this case, NCR-Fwd is initially ON (i.e. providing a forwarding function). Whilst in RRC Idle, the NCR-MT may receive a paging message, or a wake up timer may expire. On receipt of said paging message at the NCR 100, or initiation of the wake up timer, NCR-Fwd is turned to OFF. The NCR-MT performs RRC connection establishment (step 2), using RRC Setup Request, to a gNB 700. In response to receiving RRCSetup message (step 3), transmitted by the gNB 700 in response, the NCR-MT may configure NCR-Fwd to ON (i.e. to resume forwarding). The NCR-MT transmits RRC Setup Complete (step 4).

Referring to FIG. 10b, the NCR 100 (NCR-MT) is in RRC Inactive, and in this case, NCR-Fwd is initially ON (i.e. providing a forwarding function, or configured to provide a forwarding function). Whilst in RRC Inactive, the NCR-MT may receive a paging message, e.g. from gNB (step 1). On receipt of said message at the NCR 100, NCR-Fwd is turned to OFF. The NCR-MT may then perform RRC connection estab-lishment (step 2), using a RRCResume Request, to a gNB 700. In response to receiving RRC Resume message (step 3) transmitted by the gNB, the NCR-MT may configure NCR-Fwd to ON (i.e. to resume forwarding). The CR-MT then transmits RRC Resume Complete (step 4).

Referring to FIG. 10c, the NCR 100 (NCR-MT) is in RRC Inactive (or in RRC Idle
not shown in the figure), and NCR-Fwd is initially ON (or providing a forwarding function), such as described in FIG. 10b. However, in this example, NCR-MT may select a different cell (i.e. following or as a result of cell reselection). In this case, in response to a different cell being selected, NCR-Fwd is turned OFF. The NCR-MT performs RRC connection establishment with a gNB 701 of the new cell (step 2), using an RRCResume Request. In response to receiving RRC Resume message (step 3), transmitted by the gNB 701 in response, the NCR-MT may configure NCR-Fwd to ON (i.e. to resume forwarding). The NCR-MT transmits RRC Resume Complete (step 4).

The above example, in the case where the NCR-Fwd has been turned OFF due the NCR-MT having selected a different cell in RRC inactive or RRC idle, described in FIG. 10c, is useful as the forwarding configuration for NCR-Fwd may be the same regardless of which donor gNB or cell that the NCR-MT is connected to. As a further example, the NCR-MT might select a different cell that is associated with the same donor gNB (the cells come from the same site, such as sectorized cell site), but where the coverage provided through the forwarding configuration remains the same.

In another example, NCR-Fwd can be turned ON if step 4 of the procedure (i.e. as described in FIGS. 10a-c) is successfully received, i.e. in response to RRCSetup-Complete or the RRCResumeComplete.

In further examples to turn on NCR-Fwd, conditions or triggers to resume (or continue) forwarding, can additionally, or instead, be at least one of (but not limited to):
That the RRC Resume or RRC establishment was triggered by a timer.
That the RRC Resume or RRC establishment was not triggered by an error case, such as:
   Unable to find a suitable cell—this is useful if the NCR-MT has been struggling with radio conditions previously and where providing a new configuration would be beneficial. NCR-MT may indicate problems.
   Having left RRC inactive to RRC idle.
   Having left RRC connected mode due to errors or RRC connection release being requested by upper layers.
   Having been released by another gNB after AS security not being established.
   No errors occurring recently, such as RLFs or Beam Failures etc.
   No PLMN found, etc.
AS security having been established.
NCR not having been released and having its NCR-Fwd being switch OFF.
NCR-Fwd having been turned OFF due to NCR-MT selecting a different cell or donor gNB.

In another example, when an NCR (e.g. NCR 100) is being handed over from one gNB (e.g., donor gNB) to another (e.g., another donor gNB), the NCR-Fwd will remain (i.e. may be configured to be) OFF during the handover procedure and then (configured to be) turned ON when handover procedure is completed. In detail this can mean that the NCR-Fwd is turned OFF when the RRCReconfiguration message is received from the source donor gNB (i.e. current gNB), and then turned on once the RRCReconfiguration complete has been sent by the target donor gNB.

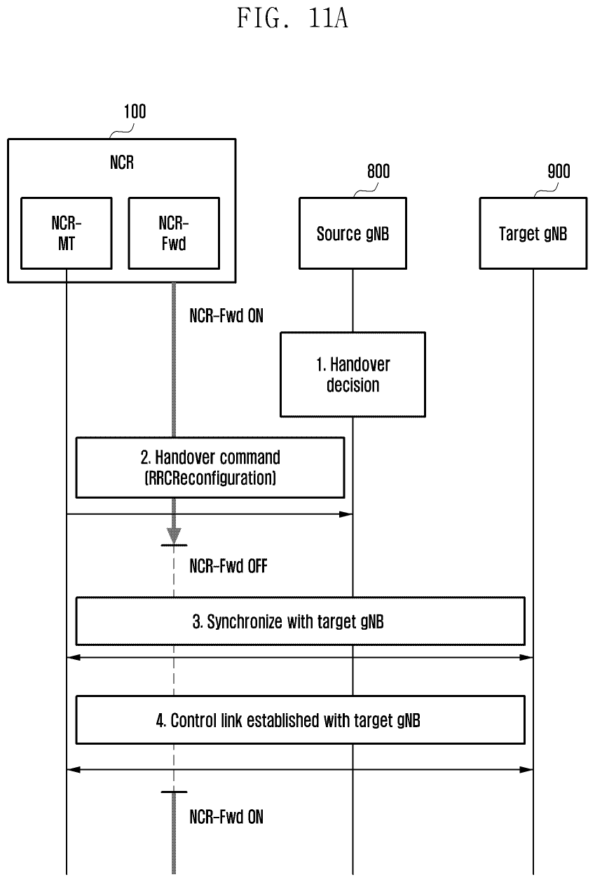

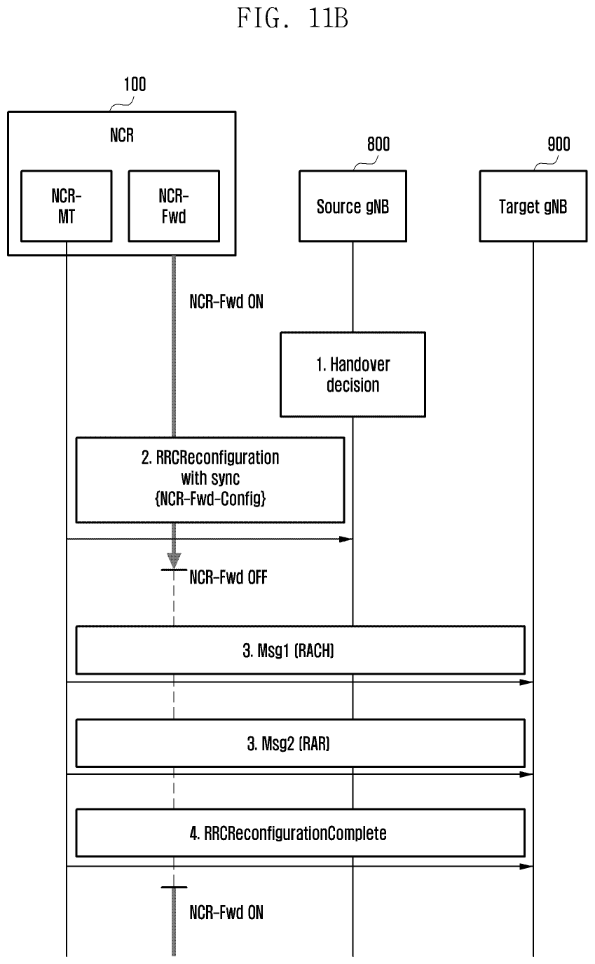

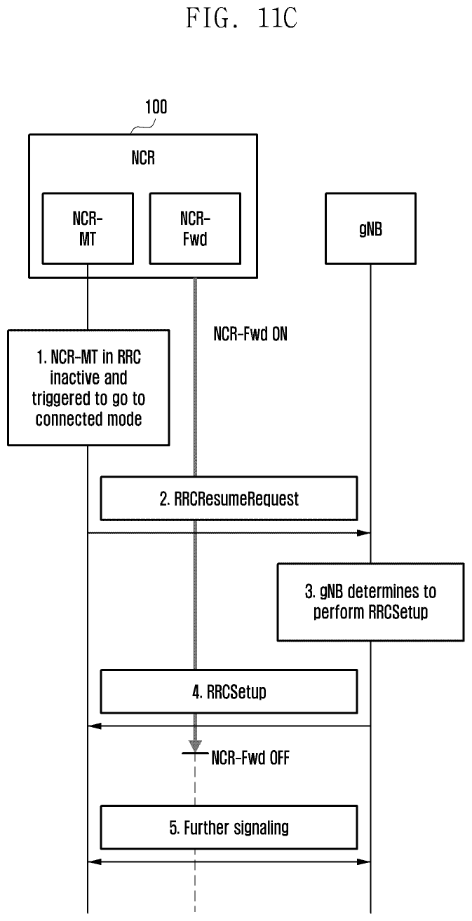

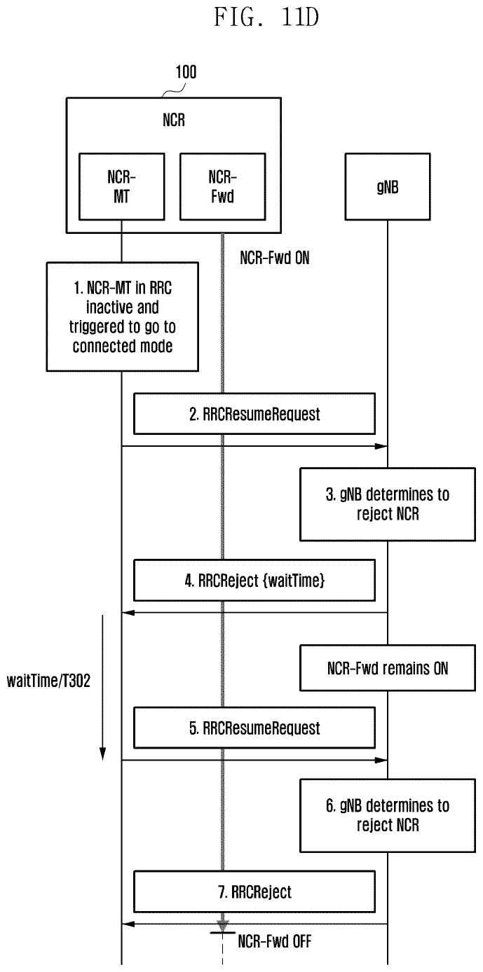

The above example is illustrated by reference to FIG. 11, which illustrates an example of controlling NCR-Fwd, of NCR 100, during handover. FIG. 11a illustrates an example where NCR-Fwd may initially be ON (that is, providing a forwarding function), and is turned OFF when a handover command (Step 2, RRCReconfiguration) is transmitted by the NCR-MT to the current (source) gNB 800. For instance, this may follow a handover decision made by the source gNB 800 (Step 1), or may follow a decision made by NCR 100. Thus, NCR-Fwd remains OFF during the handover procedure (i.e. during Step 3, Synchronise with target gNB 900). Following establishment of the control link with the new (target) gNB 900, (Step 4), NCR-Fwd may be controlled to be turned ON (i.e. the forwarding function may be resumed).

FIG. 11b illustrates a further example of controlling the NCR-Fwd, of NCR 100, during handover. Similarly to FIG. 11a, NCR-Fwd may initially be ON (that is, providing a forwarding function). On initiation of handover (i.e. step 1, Handover decision, at the gNB 800), the NCR-MT may transmit a handover command (RRCReconfiguration with sync), having a flag, or indicator, to turn on NCR-Fwd when handover is complete. For example, this is shown as NCR-Fwd-Config. Similarly to FIG. 11a, on transmission of RRCReconfiguration with sync, NCR-Fwd may be turned OFF, for the duration of the handover procedure (step 3, Msg1 (RACH); Msg2 (RAR)). Following establishment of the control link with the new (target) gNB 900, (Step 4), NCR-Fwd may be controlled to be turned ON (i.e. the forwarding function may be resumed), in response to the prior transmitted flag (indicator).

For the above-detailed examples, NCR-Fwd may be turned on responsive to at least one condition being fulfilled (i.e. one or more conditions as described with reference to the preceding examples). In an example, a condition may be the NCR-Fwd having been configured in the RRCReconfiguration, i.e. that an NCR-Fwd configuration exists. This may be useful as an option to the network where in some cases the NCR-Fwd may be configured in the handover command (RRCReconfiguration) and in some other cases it can be configured in the target donor gNB entirely.

In some examples, when receiving the RRCReconfiguration with sync from source donor gNB, the NCR may be configured to discard any NCR-Fwd configuration in some cases. In these cases the NCR cannot be configured to perform any forwarding after the handover is completed, but needs to be re-configured again.

In another example, the NCR-MT can include a flag in Step 5 (not shown) that it has resumed NCR-Fwd, i.e. turned NCR-Fwd ON. This can be applicable to RRC messages such as RRCSetupComplete, RRCResumeComplete or RRCReestablish-mentComplete. This can be useful for the donor gNB if the conditions are not fully known to the donor gNB and can also serve as a reminder or warning message. It can also be included in a RRCReconfigurationComplete message upon handovers.

According to an example of the present disclosure, a method, of a repeater node configured to perform a forwarding function in a network, comprises: performing cell selection following radio link failure; in response to detecting a trigger for modifying the forwarding function following initiation of cell selection, modifying the forwarding function (e.g., turn NCR-Fwd from OFF to ON).

According to a further example, modifying the forwarding function is further performed in response to fulfilment of at least one condition (e.g., in respect of RRC Reestablishment or RRC Resume) being fulfilled.

According to a further example, the detected trigger is receipt of a message indicative of successful completion of RRC procedure.

### Controlling NCR-Fwd During RRC Resume

A NCR-Fwd may remain forwarding while NCR-MT is in RRC inactive if the donor gNB has configured the NCR 100 to do so.

However, it is imagined that an NCR that is forwarding when NCR-MT is in RRC inactive state, may need to occasionally re-connect to its donor gNB, to for instance update the NCR-Fwd configuration or similar. And for this there are already in-troduced procedures such as RAN-paging and periodic RNAU, as well as initiation to perform RRCResume if the upper layers have configured the NCR to do so, for instance by implementation.

However, there are some cases where the RRC resume procedures may fail, be rejected or the NCR may need to be re-configured. In these cases there may need to be changes to how the NCR-Fwd operates.

In an example, in relation to FIG. 11c, the NCR-MT is firstly in RRC inactive mode and triggered to go to connected mode (1). NCR-Fwd may initially be ON (that is, providing a forwarding function). When an RRC setup message (4) is received in response to the NCR-MT sending the RRC Resume request (2) (i.e. if the gNB de-termines to perform RRCSetup (3)), the NCR-Fwd will be turned OFF if the NCR-Fwd is ON. This can be seen in FIG. 11c. This example can be seen in specification example 5.

In an example, when an RRC reject message is received in response to the NCR-MT sending the RRC Resume request, the NCR-Fwd will be turned OFF if the NCR-Fwd is ON. In other words, if the UE is rejected, NCR-Fwd will be turned OFF. This can for instance be useful in the case where RRC reject is due to high load, preventing high load such as during emergency cases or due to network error or network reconfiguration.

Similarly, in another example, when the RRC reject message is received in response to the NCR-MT sending the RRC Resume request, the NCR-Fwd will remain turned ON. This can be useful in the case where the NCR should continue to provide coverage despite the high load.

Whether the NCR-Fwd is turned OFF or ON when receiving an RRC reject message can be related to whether the waitTime (T302) is configured in the RRC reject message. The wait time is related to how long the rejected device shall wait before at-tempting to connect again. During this time it could either make sense to keep NCR-Fwd ON or OFF. The reason why it would be useful to keep the NCR-Fwd ON is that while the NCR-MT is unable to resume, it has still yet to be released to RRC idle and there may not be a need to turn NCR-Fwd OFF to disrupt possible UEs being served through the NCR-Fwd.

As an example of the above in relation to FIG. 11d, the NCR-MT is firstly in RRC inactive mode and triggered to go to connected mode (1). NCR-Fwd may initially be ON (that is, providing a forwarding function). When the NCR-MT (e.g. RRCRe-sumeRequest (2)) is rejected with a waitTime (e.g. RRCReject {waitTime} (4)), (i.e. if the gNB determines to reject the NCR (3)) the NCR-Fwd will remain ON. When NCR-MT (e.g. RRCResumeRequest (5)) is rejected (6) but without the waitTime (e.g.RRCReject (7)), the NCR-Fwd will be OFF. This can be seen in FIG. 11d.

In another example, it can be configurable whether the NCR-Fwd is turned OFF due to any of the above examples, i.e receiving RRCReject or RRCSetup. This can be configured via one or more of:
A flag in RRCReject message
A configured flag broadcasted in system information
A dedicatedly configured flag in the NCR-MT RRC configuration

In other words, in various examples NCR-Fwd may be turned off or on or maintained off or on dependent on a gNB's response to an RRCResumeRequest (i.e. in response to RRCSetup, RRCReject with or without a waitTime, RRCResume, or RRCResume-Complete).

### Backhaul Configuration

In the below examples, examples of the NCR backhauling configuration are described in relation to modifying the NCR-Fwd function (i.e. when NCR-Fwd is turned On or Off). It will be appreciated that the below examples may apply to any of the above-detailed examples with regard to the NCR-Fwd function, of NCR 100, being turned on, or off, where applicable, in additional regard to the configurations described below.

In an example, resuming NCR-Fwd (or turning NCR-Fwd ON) also includes resuming the NCR backhauling configuration. This is can be important or useful as the backhauling configuration is also important to ensure that the full NCR operation is efficient. For example, if a backhaul link was disconnected or released following RLF, when turning NCR-Fwd ON (e.g., following RRC reestablishment) the backhaul configuration may be resumed (e.g., if camped on the same cell as before RLF or if camped on a cell controlled by the same gNB as that which controlled the cell the NCR camped on before RLF, the backhaul configuration may be resumed by the NCR).

In another example, the backhauling configuration is not resumed when NCR-Fwd is turned ON. This could be crucial in cases when the NCR re-establishes/resumes/sets up with a new gNB or a gNB that the NCR has not been connected with for a while. This is important as the NCR-Fwd configuration may be the same regardless of which donor gNB that the NCR-MT is connected to, but the backhauling configuration could be very different.

In another example, the NCR decides by itself whether to continue to the NCR backhauling configuration. This can for instance depend on whether it is likely that the backhauling configuration should be the same or not, or whether a lot of time has passed since the last backhauling configuration was in use.

In another example, the network can configure whether the NCR shall resume the backhauling configuration last used/received by the donor gNB, or whether it shall reset it. This can be a flag in broadcasted configurations (SIB1 or any other SIBs) or configured in a configuration message.

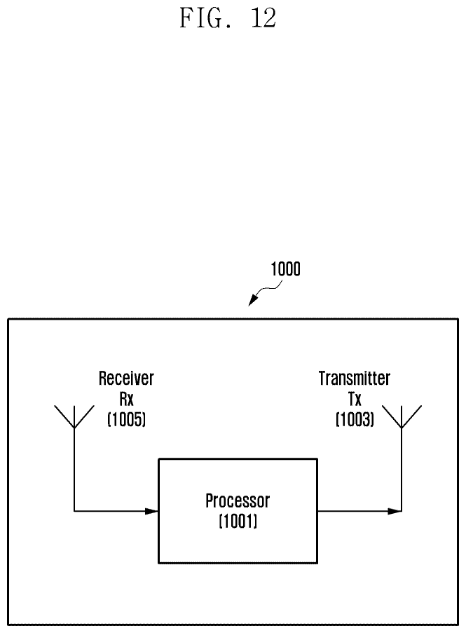

FIG. 12 is a block diagram of an exemplary apparatus, or network entity that may be used in examples of the present disclosure. The skilled person will appreciate said entity may be implemented, for example, as a network element on a dedicated hardware, as a software instance running on a dedicated hardware, and/or as a vir-tualised function instantiated on an appropriate platform, e.g. on a cloud infrastructure.

The entity 1000 comprises a processor (or controller) 1001, a transmitter 1003 and a receiver 1005. The receiver 1005 is configured for receiving one or more messages from one or more other network entities, for example as described above. The transmitter 1003 is configured for transmitting one or more messages to one or more other network entities, for example as described above. The processor 1001 is configured for performing one or more operations, for example according to the op-erations as described above.

The techniques described herein may be implemented using any suitably configured apparatus and/or system. Such an apparatus and/or system may be configured to perform a method according to any aspect, embodiment, example or claim disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the present disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement certain examples of the present disclosure. Accordingly, certain examples provide a program comprising code for implementing a method, apparatus or system according to any example, em-bodiment, aspect and/or claim disclosed herein, and/or a machine-readable storage storing such a program. Still further, such programs may be conveyed electronically via any medium, for example a communication signal carried over a wired or wireless connection.

While the invention has been shown and described with reference to certain examples, it will be understood by those skilled in the art that various changes in form and detail may be made therein without departing from the scope of the invention, as defined by the appended claims.

Certain examples of the present disclosure provide one or more techniques as disclosed in the following Annex to the description. The skilled person will appreciate that any of these techniques may be applied in combination with any of the techniques described above and illustrated in the Figures.

### Annex to the Description

This Annex includes examples of text for representing various examples according to the present disclosure in a specification, as indicated above. It will be appreciated that these examples are non-limiting.

### Specification Example 1 (TS 38.331 v17.3.0)

### 5.3.10 Radio Link Failure Related Actions

### 5.3.10.1Detection of Physical Layer Problems in RRC_CONNECTED

The UE shall:
1> if any DAPS bearer is configured, upon receiving N310 consecutive “out-of-sync” indications for the source SpCell from lower layers and T304 is running:
   2> start timer T310 for the source SpCell.
1> upon receiving N310 consecutive “out-of-sync” indications for the SpCell from lower layers while neither T300, T301, T304, T311, T316 nor T319 are running:
   2> start timer T310 for the corresponding SpCell.
   2> for NCR-MT:
      3> indicate to NCR-Fwd to turn OFF

### 5.3.10.2 Recovery of Physical Layer Problems

Upon receiving N311 consecutive “in-sync” indications for the SpCell from lower layers while T310 is running, the UE shall:
1> stop timer T310 for the corresponding SpCell.
1> stop timer T312 for the corresponding SpCell, if running.
1> for NCR-MT and if NCR-Fwd is configured and is OFF due to detection of physical layer problems:
   2> indicate to NCR-Fwd to turn ON
NOTE 1: In this case, the UE maintains the RRC connection without explicit signalling, i.e. the UE maintains the entire radio resource configuration.
NOTE 2: Periods in time where neither “in-sync” nor “out-of-sync” is reported by L1 do not affect the evaluation of the number of consecutive “in-sync” or “out-of-sync” indications.

### Specification Example 2 (TS 38.321 v17.3.0)

### 5.4.4 Scheduling Request

The Scheduling Request (SR) is used for requesting UL-SCH resources for new transmission.

The MAC entity may be configured with zero, one, or more SR configurations. An SR configuration consists of a set of PUCCH resources for SR across different BWPs and cells. For a logical channel or for SCell beam failure recovery (see clause 5.17) and for consistent LBT failure recovery (see clause 5.21), at most one PUCCH resource for SR is configured per BWP. For a logical channel serving a radio bearer configured with SDT, PUCCH resource for SR is not configured for SDT. For beam failure recovery of BFD-RS set(s) of Serving Cell, up to two PUCCH resources for SR is configured per BWP. For positioning measurement gap activation/deactivation request, a dedicated SR configuration is configured.

Each SR configuration corresponds to one or more logical channels and/or to SCell beam failure recovery and/or to consistent LBT failure recovery and/or to beam failure recovery of a BFD-RS set and/or to positioning measurement gap activation/deactivation request. Each logical channel, SCell beam failure recovery, beam failure recovery of a BFD-RS set and consistent LBT failure recovery, may be mapped to zero or one SR configuration, which is configured by RRC. The SR configuration of the logical channel that triggered a BSR (clause 5.4.5) or the SCell beam failure recovery or the beam failure recovery of a BFD-RS set or the consistent LBT failure recovery (clause 5.21) (if such a configuration exists) or positioning measurement gap activation/deactivation request (clause 5.25) is considered as corresponding SR configuration for the triggered SR. Any SR configuration may be used for an SR triggered by Pre-emptive BSR (clause 5.4.7) or Timing Advance reporting (clause 5.4.8).

RRC configures the following parameters for the scheduling request procedure:
sr-ProhibitTimer (per SR configuration);
sr-TransMax (per SR configuration).

The following UE variables are used for the scheduling request procedure:
SR_COUNTER (per SR configuration).

If an SR is triggered and there are no other SRs pending corresponding to the same SR configuration, the MAC entity shall set the SR_COUNTER of the corresponding SR configuration to 0.

When an SR is triggered, it shall be considered as pending until it is cancelled.

All pending SR(s) for BSR triggered according to the BSR procedure (clause 5.4.5) prior to the MAC PDU assembly shall be cancelled and each respective sr-ProhibitTimer shall be stopped when the MAC PDU is transmitted and this PDU includes a Long or Short BSR MAC CE which contains buffer status up to (and including) the last event that triggered a BSR (see clause 5.4.5) prior to the MAC PDU assembly. All pending SR(s) for BSR triggered according to the BSR procedure (clause 5.4.5) shall be cancelled and each respective sr-ProhibitTimer shall be stopped when the UL grant(s) can accommodate all pending data available for transmission.

The MAC entity shall for each pending SR not triggered according to the BSR procedure (clause 5.4.5) for a Serving Cell:
1> if this SR was triggered by Pre-emptive BSR procedure (see clause 5.4.7) prior to the MAC PDU assembly and a MAC PDU containing the relevant Pre-emptive BSR MAC CE is transmitted; or
1> if this SR was triggered by beam failure recovery (see clause 5.17) of an SCell and a MAC PDU is transmitted and this PDU includes a MAC CE for BFR which contains beam failure recovery information for this SCell; or
1> if this SR was triggered by beam failure recovery (see clause 5.17) for a BFD-RS set of a Serving Cell and a MAC PDU is transmitted and this PDU includes an Enhanced BFR MAC CE or a Truncated Enhanced BFR MAC CE which contains beam failure recovery information for this BFD-RS set of the Serving Cell; or
1> if this SR was triggered by beam failure recovery (see clause 5.17) of an SCell and this SCell is deactivated (see clause 5.9); or
1> if this SR was triggered by beam failure recovery (see clause 5.17) for a BFD-RS set of an SCell and this SCell is deactivated (see clause 5.9); or
1> if the SR is triggered by positioning measurement gap activation/deactivation request (see clause 5.25) and the Positioning Measurement Gap Activation/Deactivation Request MAC CE that triggers the SR has already been cancelled; or
1> if this SR was triggered by consistent LBT failure recovery (see clause 5.21) of an SCell and a MAC PDU is transmitted and the MAC PDU includes an LBT failure MAC CE that indicates consistent LBT failure for this SCell; or
1> if this SR was triggered by consistent LBT failure recovery (see clause 5.21) of an SCell and all the triggered consistent LBT failure(s) for this SCell are cancelled; or
1> if this SR was triggered by Timing Advance reporting (see clause 5.4.8) and all the triggered Timing Advance reports are cancelled:
   2> cancel the pending SR and stop the corresponding sr-ProhibitTimer, if running.

Only PUCCH resources on a BWP which is active at the time of SR transmission occasion are considered valid. As long as at least one SR is pending, the MAC entity shall for each pending SR:
1> if the MAC entity has no valid PUCCH resource configured for the pending SR:
   2> for NCR-MT, turn NCR-Fwd OFF
   2> initiate a Random Access procedure (see clause 5.1) on the SpCell and cancel the pending SR.
1> else, for the SR configuration corresponding to the pending SR:
   2> when the MAC entity has an SR transmission occasion on the valid PUCCH resource for SR configured; and
   2> if sr-ProhibitTimer is not running at the time of the SR transmission occasion; and
   2> if the PUCCH resource for the SR transmission occasion does not overlap with a measurement gap:
      3> if the PUCCH resource for the SR transmission occasion overlaps with neither a UL-SCH resource whose simultaneous transmission with the SR is not allowed by configuration of simultaneousPUCCH-PUSCH or simultaneousPUCCH-PUSCH-SecondaryPUCCHgroup or simultaneousSR-PUSCH-diffPUCCH-Groups nor an SL-SCH resource; or
      3> if the MAC entity is able to perform this SR transmission simultaneously with the transmission of the SL-SCH resource; or
      3> if the MAC entity is configured with Ich-basedPrioritization, and the PUCCH resource for the SR transmission occasion does not overlap with the PUSCH duration of an uplink grant received in a Random Access Response or with the PUSCH duration of an uplink grant addressed to Temporary C-RNTI or with the PUSCH duration of a MSGA payload, and the PUCCH resource for the SR transmission occasion for the pending SR triggered as specified in clause 5.4.5 overlaps with any other UL-SCH resource(s), and the physical layer can signal the SR on one valid PUCCH resource for SR, and the priority of the logical channel that triggered SR is higher than the priority of the uplink grant(s) for any UL-SCH resource(s) where the uplink grant was not already de-prioritized and its simultaneous transmission with the SR is not allowed by configuration of simultaneousPUCCH-PUSCH or simultaneousPUCCH-PUSCH-SecondaryPUCCHgroup or simultaneousSR-PUSCH-diffPUCCHgroups, and the priority of the uplink grant is determined as specified in clause 5.4.1; or
      3> if both sl-PrioritizationThres and ul-PrioritizationThres are configured and the PUCCH resource for the SR transmission occasion for the pending SR triggered as specified in clause 5.22.1.5 overlaps with any UL-SCH resource(s) carrying a MAC PDU, and the value of the priority of the triggered SR determined as specified in clause 5.22.1.5 is lower than sl-PrioritizationThres and the value of the highest priority of the logical channel(s) in the MAC PDU is higher than or equal to ul-PrioritizationThres and any MAC CE prioritized as described in clause 5.4.3.1.3 is not included in the MAC PDU and the MAC PDU is not prioritized by upper layer according to TS 23.287 [19]; or
      3> if an SL-SCH resource overlaps with the PUCCH resource for the SR transmission occasion for the pending SR triggered as specified in clause 5.4.5, and the MAC entity is not able to perform this SR transmission simultaneously with the transmission of the SL-SCH resource, and either transmission on the SL-SCH resource is not prioritized as described in clause 5.22.1.3.1a or the priority value of the logical channel that triggered SR is lower than ul-PrioritizationThres, if configured; or
      3> if an SL-SCH resource overlaps with the PUCCH resource for the SR transmission occasion for the pending SR triggered as specified in clause 5.22.1.5, and the MAC entity is not able to perform this SR transmission simultaneously with the transmission of the SL-SCH resource, and the priority of the triggered SR determined as specified in clause 5.22.1.5 is higher than the priority of the MAC PDU determined as specified in clause 5.22.1.3.1a for the SL-SCH resource:
         4> consider the SR transmission as a prioritized SR transmission.
         4> consider the other overlapping uplink grant(s), if any, as a de-prioritized uplink grant(s), except for the overlapping uplink grant(s) whose simultaneous transmission is allowed by configuration of simultaneousPUCCH-PUSCH or simultaneousPUCCH-PUSCH-SecondaryPUCCHgroup or simultaneousSR-PUSCH-diffPUCCH-Groups;
         4> if the de-prioritized uplink grant(s) is a configured uplink grant configured with autonomousTx whose PUSCH has already started:
         5> stop the configuredGrantTimer for the corresponding HARQ process of the de-prioritized uplink grant(s);
         5> stop the cg-RetransmissionTimer for the corresponding HARQ process of the de-prioritized uplink grant(s).
         4> if SR_COUNTER<sr-Trans Max:
         5> instruct the physical layer to signal the SR on one valid PUCCH resource for SR;
         5> if LBT failure indication is not received from lower layers:
         6> increment SR_COUNTER by 1;
         6> start the sr-ProhibitTimer.
         5> else if Ibt-FailureRecoveryConfig is not configured:
         6> increment SR_COUNTER by 1.
         4> else:
         5> notify RRC to release PUCCH for all Serving Cells;
         5> notify RRC to release SRS for all Serving Cells;
         5> clear any configured downlink assignments and uplink grants;
         5> clear any PUSCH resources for semi-persistent CSI reporting;
         5> for NCR-MT, turn NCR-Fwd OFF
         5> initiate a Random Access procedure (see clause 5.1) on the SpCell and cancel all pending SRs.
      3> else:
         4> consider the SR transmission as a de-prioritized SR transmission.

### 5.1.6 Completion of the Random Access Procedure

Upon completion of the Random Access procedure, the MAC entity shall:
1> discard any explicitly signalled contention-free Random Access Resources for 2-step RA type and 4-step RA type except the 4-step RA type contention-free Random Access Resources for beam failure recovery request, if any;
1> flush the HARQ buffer used for transmission of the MAC PDU in the Msg3 buffer and the MSGA buffer.

Upon successful completion of the Random Access procedure initiated for DAPS handover, the target MAC entity shall:
1> indicate the successful completion of the Random Access procedure to the upper layers.

For NCR-MT, upon successful completion of the Random Access procedure for an NCR-MT, the NCR-MT shall:
1> turn NCR-Fwd ON.

### Specification Example 3 (TS 38.331 v17.3.0)

### 5.5.4 Measurement Report Triggering

### 5.5.4.1 General

If AS security has been activated successfully, the UE shall:
1> for each measId included in the measIdList within VarMeasConfig:
   2> if the corresponding reportConfig includes a reportType set to eventTriggered or periodical: <OMITTED>
   2> if the reportType is set to eventTriggered and if the entry condition applicable for this event, i.e. the event corresponding with the eventId of the corresponding reportConfig within VarMeasConfig, is fulfilled for one or more applicable cells for all measurements after layer 3 filtering taken during timeToTrigger defined for this event within the VarMeasConfig, while the VarMeasReportList does not include a measurement reporting entry for this measId (a first cell triggers the event):
      3> include a measurement reporting entry within the VarMeasReportList for this measld;
      3> set the numberOfReportsSent defined within the VarMeasReportList for this measId to 0;
      3> include the concerned cell(s) in the cellsTriggeredList defined within the Var MeasReportList for this measId;
      3> if useT312 is set to true in reportConfig for this event:
         4> if T310 for the corresponding SpCell is running; and
         4> if T312 is not running for corresponding SpCell:
         5> start timer T312 for the corresponding SpCell with the value of T312 configured in the corresponding measObjectNR;
      3> for NCR, if ncr-Fwd-SwitchOff is configured for the event:
         4> turn NCR-Fwd OFF
      3> initiate the measurement reporting procedure, as specified in 5.5.5;

### -ReportConfigNR

The IE ReportConfigNR specifies criteria for triggering of an NR measurement reporting event or of a CHO, CPA or CPC event or of an L2 U2N relay measurement reporting event. For events labelled AN with N equal to 1, 2 and so on, measurement reporting events and CHO, CPA or CPC events are based on cell measurement results, which can either be derived based on SS/PBCH block or CSI-RS.

ReportConfigNR information element

-- ASN1START
-- TAG-REPORTCONFIGNR-START

| | |
|---|---|
| ReportConfigNR ::= | SEQUENCE { |
| reportType | CHOICE { |

periodical
PeriodicalReportConfig,

| | |
|---|---|
| eventTriggered | EventTriggerConfig, |

...,

| | |
|---|---|
| reportCGI | ReportCGI, |
| reportSFTD | ReportSFTD-NR, |
| condTriggerConfig-r16 | CondTriggerConfig- |

r16,

| | |
|---|---|
| cli-Periodical-r16 | CLI- |

PeriodicalReportConfig-r16,

| | |
|---|---|
| cli-EventTriggered-r16 | CLI- |

EventTriggerConfig-r16,

| | |
|---|---|
| rxTxPeriodical-r17 | RxTxPeriodical-r17 |

}
}

| | |
|---|---|
| | <OMITTED> |
| EventTriggerConfig::= | SEQUENCE { |
| eventId | CHOICE { |
| eventA1 | SEQUENCE { |

a1-Threshold
MeasTriggerQuantity,

| | |
|---|---|
| reportOnLeave | BOOLEAN, |
| hysteresis | Hysteresis, |
| timeToTrigger | TimeToTrigger |

},

| | |
|---|---|
| eventA2 | SEQUENCE { |

a2-Threshold
MeasTriggerQuantity,

| | |
|---|---|
| reportOnLeave | BOOLEAN, |
| hysteresis | Hysteresis, |
| timeToTrigger | TimeToTrigger |

},

| | |
|---|---|
| eventA3 | SEQUENCE { |

a3-Offset
MeasTriggerQuantityOffset,

| | |
|---|---|
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA4 | SEQUENCE { |

a4-Threshold
MeasTriggerQuantity,

| | |
|---|---|
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA5 | SEQUENCE { |

```
      a5-Threshold1
MeasTriggerQuantity,
      a5-Threshold2
MeasTriggerQuantity,
```

| | |
|---|---|
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA6 | SEQUENCE { |

a6-Offset
MeasTriggerQuantityOffset,

| | |
|---|---|
| reportOnLeave | BOOLEAN, |
| hysteresis | Hysteresis, |
| timeToTrigger | TimeToTrigger, |
| useAllowedCellList | BOOLEAN |

```
    },
    ...,
    [[
```

| | |
|---|---|
| eventX1-r17 | SEQUENCE { |
| x1-Threshold1-Relay-r17 | SL- |

MeasTriggerQuantity-r16,
x1-Threshold2-r17
MeasTriggerQuantity,

| | |
|---|---|
| reportOnLeave-r17 | BOOLEAN, |
| hysteresis-r17 | Hysteresis, |
| timeToTrigger-17 | TimeToTrigger, |
| useAllowedCellList-r17 | BOOLEAN |

},

| | |
|---|---|
| eventX2-r17 | SEQUENCE { |
| x2-Threshold-Relay-r17 | SL- |

MeasTriggerQuantity-r16,

| | |
|---|---|
| reportOnLeave-r17 | BOOLEAN, |
| hysteresis-r17 | Hysteresis, |
| timeToTrigger-r17 | TimeToTrigger |

},

| | |
|---|---|
| eventD1-r17 | SEQUENCE { |
| distanceThreshFromReference1-r17 | INTEGER(1.. |

65525),

| | |
|---|---|
| distanceThreshFromReference2-r17 | INTEGER(1.. |

```
65525)
      referenceLocation1-r17
ReferenceLocation-r17,
      referenceLocation2-r17
ReferenceLocation-r17,
```

| | |
|---|---|
| reportOnLeave-17 | BOOLEAN, |

hysteresisLocation-r17
HysteresisLocation-r17,

| | |
|---|---|
| timeToTrigger-r17 | TimeToTrigger |

```
    }
    ]]
  },
```

| | |
|---|---|
| rsType | NR-RS-Type, |
| reportInterval | ReportInterval, |
| reportAmount | ENUMERATED {r1, r2, r4, r8, r16, |

r32, r64, infinity},

| | |
|---|---|
| reportQuantityCell | MeasReportQuantity, |
| maxReportCells | INTEGER (1..maxCellReport), |
| reportQuantityRS-Indexes | MeasReportQuantity |

OPTIONAL, -- Need R

| | |
|---|---|
| maxNrofRS-IndexesToReport | INTEGER |
| (1..maxNrofIndexesToReport) OPTIONAL, | -- Need R |
| includeBeamMeasurements | BOOLEAN, |
| reportAddNeighMeas | ENUMERATED {setup} |

```
OPTIONAL, -- Need R
  ...,
  [[
```

| | |
|---|---|
| measRSSI-ReportConfig-r16 | MeasRSSI-ReportConfig-r16 |

OPTIONAL, -- Need R

| | |
|---|---|
| useT312-r16 | BOOLEAN |

OPTIONAL, -- Need M

| | |
|---|---|
| includeCommonLocationInfo-r16 | ENUMERATED {true} |

OPTIONAL, -- Need R

| | |
|---|---|
| includeBT-Meas-r16 | SetupRelease {BT-NameList-r16} |

OPTIONAL, -- Need M

| | |
|---|---|
| includeWLAN-Meas-r16 | SetupRelease {WLAN-NameList-r16} |

OPTIONAL, -- Need M

| | |
|---|---|
| includeSensor-Meas-r16 | SetupRelease {Sensor-NameList- |

```
r16} OPTIONAL -- Need M
  ]],
  [[
```

| | |
|---|---|
| coarseLocationRequest-r17 | ENUMERATED {true} |

OPTIONAL, -- Need R

| | |
|---|---|
| reportQuantityRelay-r17 | SL-MeasReportQuantity-r16 |

```
OPTIONAL -- Need R
  ]],
  [[
```

| | |
|---|---|
| ncr-Fwd-SwitchOff-r18 | ENUMERATED {true} |

OPTIONAL, -- Need R
]]
}

<OMITTED>

-- TAG-REPORTCONFIGNR-STOP
-- ASN1STOP

ReportConfigNR field descriptions

reportType
Type of the configured measurement report. In MR-DC, network does not configure report of
type reportCGI using SRB3. The condTriggerConfig is used for CHO, CPA or CPC
configuration.

EventTriggerConfig field descriptions

a3-Offset/a6-Offset
Offset value(s) to be used in NR measurement report triggering condition for event a3/a6. The actual
value is field value * 0.5 dB.
aN-ThresholdM
Threshold value associated to the selected trigger quantity (e.g. RSRP, RSRQ, SINR) per RS Type
(e.g. SS/PBCH block, CSI-RS) to be used in NR measurement report triggering condition for event
number aN. If multiple thresholds are defined for event number aN, the thresholds are differentiated by
M. The network configures aN-Threshold1 only for events A1, A2, A4, A5 and a5-Threshold2 only for
event A5. In the same eventA5, the network configures the same quantity for the MeasTriggerQuantity
of the a5-Threshold1 and for the Meas TriggerQuantity of the a5-Threshold2.
channelOccupancyThreshold
RSSI threshold which is used for channel occupancy evaluation.
coarseLocationRequest
This field is used to request UE to report coarse location information.
distanceThreshFromReference1, distanceThreshFromReference2
Threshold value associated to the distance from a reference location configured with
referenceLocation1 or referenceLocation2. Each step represents 50m.
eventId
Choice of NR event triggered reporting criteria.
maxNrofRS-IndexesToReport
Max number of RS indexes to include in the measurement report for A1-A6 events.
maxReportCells
Max number of non-serving cells to include in the measurement report.
ncr-Fwd-SwitchOff
Indicates NCR-Fwd to switch OFF if event is satisfied.
referenceLocation1, referenceLocation2
Reference locations used for eventD1. The referenceLocation1 is associated to serving cell and
referenceLocation2 is associated to neighbour cell.
reportAddNeighMeas
Indicates that the UE shall include the best neighbour cells per serving frequency.
reportAmount
Number of measurement reports applicable for eventTriggered as well as for periodical report types.
reportOnLeave
Indicates whether or not the UE shall initiate the measurement reporting procedure when the leaving
condition is met for a cell in cellsTriggeredList, as specified in 5.5.4.1.
Indicates whether or not the UE shall initiate the measurement reporting procedure when the leaving
condition is met if configured in eventD1, as specified in 5.5.4.1.
reportQuantityCell
The cell measurement quantities to be included in the measurement report.
reportQuantityRS-Indexes
Indicates which measurement information per RS index the UE shall include in the measurement report.
timeToTrigger
Time during which specific criteria for the event needs to be met in order to trigger a measurement
report.
useAllowedCellList
Indicates whether only the cells included in the allow-list of the associated measObject are applicable as
specified in 5.5.4.1.
useT312
If value TRUE is configured, the UE shall use the timer T312 with the value t312 as specified in the
corresponding measObjectNR. If value FALSE is configured, the timer T312 is considered as disabled.
Network configures value TRUE only if reportType is set to eventTriggered.
xN-ThresholdM
Threshold value associated to the selected trigger quantity (e.g. RSRP, RSRQ, SINR) per RS Type
(e.g. SS/PBCH block, CSI-RS) to be used in NR measurement report triggering condition for event xN.
If multiple thresholds are defined for event number xN, the thresholds are differentiated by M. x1-
Threshold1 and x2-Threshold indicates the threshold value for the serving L2 U2N Relay UE, x1-
Threshold2 indicates the threshold value for the NR Cells.

PeriodicalReportConfig field descriptions

coarseLocationRequest
This field is used to request UE to report coarse location information.
maxNrofRS-IndexesToReport
Max number of RS indexes to include in the measurement report.
maxReportCells
Max number of non-serving cells to include in the measurement report.
reportAddNeighMeas
Indicates that the UE shall include the best neighbour cells per serving frequency.
reportAmount
Number of measurement reports applicable for eventTriggered as well as for periodical report
types
reportQuantityCell
The cell measurement quantities to be included in the measurement report.
reportQuantityRS-Indexes
Indicates which measurement information per RS index the UE shall include in the measurement
report.
ul-DelayValueConfig
If the field is present, the UE shall perform the actual UL PDCP Packet Average Delay
measurement per DRB as specified in TS 38.314 [53] and the UE shall ignore the fields
reportQuantityCell and maxReportCells. The applicable values for the corresponding
reportinterval are (one of the) {ms120, ms240, ms480, ms640, ms1024, ms2048, ms5120,
ms10240, ms20480, ms40960, min1, min6, min12, min30}. The reportInterval indicates the
periodicity for performing and reporting of UL PDCP Packet Average Delay per DRB
measurement as specified in TS 38.314 [53].
ul-ExcessDelayConfig
If the field is present, the UE shall perform the actual UL PDCP Excess Packet Delay per DRB
measurement as specified in TS 38.314 [53] and the UE shall ignore the fields
reportQuantityCell and maxReportCells. The applicable values for the corresponding
reportinterval are (one of the) {ms120, ms240, ms480, ms640, ms1024, ms2048, ms5120,
ms10240, ms20480, ms40960, min1, min6, min12, min30}. The reportInterval indicates the
periodicity for performing and reporting of UL PDCP Excess Packet Delay per DRB
measurement as specified in TS 38.314 [53].
useAllowedCellList
Indicates whether only the cells included in the allow-list of the associated measObject are
applicable as specified in 5.5.4.1.

### Specification Example 4 (TS38.331 v17.3.0)

### 5.3.7.5 Reception of the RRCReestablishment by the UE

The UE shall:
1> stop timer T301;
1> consider the current cell to be the PCell;
1> update the K_{gNB} key based on the current K_{gNB} key or the NH, using the received nextHopChainingCount value, as specified in TS 33.501 [11];
1> store the nextHopChainingCount value indicated in the RRCReestablishment message;
1> derive the K_{RRCene} and K_{UPene} keys associated with the previously configured cipheringAlgorithm, as specified in TS 33.501 [11];
1> derive the K_{RRCint} and K_{UPint} keys associated with the previously configured integrityProtAlgorithm, as specified in TS 33.501 [11].
1> request lower layers to verify the integrity protection of the RRCReestablishment message, using the previously configured algorithm and the K_{RRCint} key;
1> if the integrity protection check of the RRCReestablishment message fails:
   2> perform the actions upon going to RRC_IDLE as specified in 5.3.11, with release cause ‘RRC connection failure’, upon which the procedure ends;
1> configure lower layers to resume integrity protection for SRB1 using the previously configured algorithm and the K_{RRCint} key immediately, i.e., integrity protection shall be applied to all subsequent messages received and sent by the UE, including the message used to indicate the successful completion of the procedure;
1> configure lower layers to resume ciphering for SRB1 using the previously configured algorithm and, the K_{RRCene} key immediately, i.e., ciphering shall be applied to all subsequent messages received and sent by the UE, including the message used to indicate the successful completion of the procedure;
1> release the measurement gap configuration indicated by the measGapConfig, if configured;
1> release the MUSIM gap configuration indicated by the musim-GapConfig, if configured;
1> release the FR2 UL gap configuration indicated by the ul-GapFR2-Config, if configured;
1> perform the L2 U2N Remote UE configuration procedure in accordance with the received sl-L2RemoteUE-Config as specified in 5.3.5.16;
1> set the content of RRCReestablishmentComplete message as follows:
   2> if the UE has logged measurements available for NR and if the RPLMN is included in plmn-IdentityList stored in VarLogMeasReport:
      3> include the logMeasAvailable in the RRCReestablishmentComplete message;
      3> if Bluetooth measurement results are included in the logged measurements the UE has available for NR:
         4> include the logMeasAvailableBT in the RRCReestablishmentComplete message;
      3> if WLAN measurement results are included in the logged measurements the UE has available for NR:
         4> include the logMeasAvailableWLAN in the RRCReestablishmentComplete message;
   2> if the sigLoggedMeasType in VarLogMeasReport is included:
      3> if T330 timer is running and the logged measurements configuration is for NR:
         4> set sigLogMeasConfigAvailable to true in the RRCReestablishmentComplete message;
      3> else:
         4> if the UE has logged measurements available for NR:
         5> set sigLogMeasConfigAvailable to false in the RRCReestablishmentComplete message;
   2> if the UE has connection establishment failure or connection resume failure information available in VarConnEstFailReport or VarConnEstFailReportList and if the RPLMN is equal to plmn-Identity stored in VarConnEstFailReport or in at least one of the entries of VarConnEstFailReportList:
      3> include connEstFailInfoAvailable in the RRCReestablishmentComplete message;
   2> if the UE has radio link failure or handover failure information available in VarRLF-Report and if the RPLMN is included in plmn-IdentityList stored in VarRLF-Report; or
   2> if the UE has radio link failure or handover failure information available in VarRLF-Report of TS 36.331 and if the UE is capable of cross-RAT RLF reporting and if the RPLMN is included in plmn-IdentityList stored in VarRLF-Report of TS 36.331 [10]:
      3> include rif-InfoAvailable in the RRCReestablishmentComplete message;
   2> if the UE has successful handover information available in VarSuccessHO-Report and if the RPLMN is included in plmn-IdentityList stored in VarSuccessHO-Report:
      3> include successHO-InfoAvailable in the RRCReestablishmentComplete message;
1> submit the RRCReestablishmentComplete message to lower layers for transmission;
1> if SIB21 is provided by the PCell:
   2> if the UE initiated transmission of an MBSInterestIndication message during the last 1 second preceding detection of radio link failure:
      3> initiate transmission of an MBSInterestIndication message in accordance with 5.9.4;
1> for NCR-MT, if ner-SwitchOn is configured in RRCReestablishment:
   2> configured NCR-Fwd to resume forwarding according to last configuration
1> the procedure ends.

### Specification Example 5 (TS 38.331 v17.3.0)

### 5.3.3.4 Reception of the RRCSetup by the UE

The UE shall perform the following actions upon reception of the RRCSetup:
1> if the RRCSetup is received in response to an RRCReestablishmentRequest, or
1> if the RRCSetup is received in response to an RRCResumeRequest or RRCResumeRequest1:
   2> if the UE is NCR-MT:
      3> indicate to NCR-Fwd to cease forwarding;
   2> if sdt-MAC-PHY-CG-Config is configured:
      3> instruct the MAC entity to stop the cg-SDT-TimeAlignmentTimer, if it is running;
      3> instruct the MAC entity to start the timeAlignmentTimer associated with the PTAG, if it is not running;
   2> if srs-PosRRC-InactiveConfig is configured:
      3> instruct the MAC entity to stop the inactivePosSRS-TimeAlignmentTimer, if it is running;
   2> discard any stored UE Inactive AS context and suspendConfig;
   2> discard any current AS security context including the K_{RRCene} key, the K_{RRCint} key, the K_{UPint} key and the K_{UPenc} key;
   2> release radio resources for all established RBs except SRB0 and broadcast MRBs, including release of the RLC entities, of the associated PDCP entities and of SDAP;
   2> release the RRC configuration except for the default L1 parameter values, default MAC Cell Group configuration, CCCH configuration and broadcast MRBs;
   2> indicate to upper layers fallback of the RRC connection;
   2> discard any application layer measurement reports which were not transmitted yet;
   2> inform upper layers about the release of all application layer measurement configurations;
   2> stop timer T380, if running;

Abbreviations/Definitions

3GPP 3rd Generation Partnership Project
5G 5th Generation
5GC 5G Core
5QI 5G QOS Identifier
5GS 5G System
5GSM 5G System Session Management
5GMM 5G System Mobility Management
AF Application Function
AI Artificial Intelligence
AM Acknowledged Mode
AMF Access and Mobility Management Function
AS Application Server
ASP Application Service Provider
AUSF Authentication Server Function
CDN Content Delivery Network
DCAF Data Collection Application Function
DNAI Data Network Access Identifier
DNN Data Network Name
DNS Domain Name Server
DRB Data Radio Bearer
eNB Evolved Node B
EPC Evolved Packet Core
FEC Forward Error Correction
Fwd Forward
FQDN Fully Qualified Domain Name
GBR Guaranteed Bit Rate
gNB Next generation Node B
GPSI Generic Public Subscription Identifier
HSS Home Subscriber Service
IAB Integrated Access and Backhaul
ID Identity/Identifier
IIOT Industrial Internet of Things
IMEI International Mobile Equipment Identities
IP Internet Protocol
I-SMF Intermediate SMF
LADN Local Area Data Network
LL SSM Lower Layer SSM
LTE Long Term Evolution
MBMS Multimedia Broadcast/Multicast Service
MBS Multicast/Broadcast Service
MBSF Multicast/Broadcast Service Function
MBSTF Multicast/Broadcast Service Transport Function
MB-SMF Multicast/Broadcast Session Management Function
MB-UPF Multicast/Broadcast User Plane Function
ML Machine Learning
MME Mobility Management Entity
MN Master Node
MNO Mobile Network Operator
Msg Message
MT Mobile Termination
NAS Non-Access Stratum
NCR Network-Controlled Repeater
NEF Network Exposure Function
NRF Network Repository Function
NG-RAN Next Generation Radio Access Network
NG-eNB Next Generation eNB
NSA Non-Standalone
NSSF Network Slice Selection Function
NTN Non-Terrestrial Networks
NUL Normal Uplink
NW Network
NWDAF Network Data Analytics Function
OS Operating System
OSAPP OS Application
PCF Policy Control Function
PCO Protocol Configuration Options
PDR Packet Detection Rule
PDU Protocol Data Unit
PMN Public Land Mobile Network
PTM Point To Multipoint
PTP Point to Point
QFI QOS Flow Identifier (ID)
QOS Quality of Service
RACH Random Access Channel
RAN Radio Access Network
RANAC RAN Area Code
RF Radio Frequency
RNA RAN Notification Area
RRC Radio Resource Control
RRM Radio Resource Management
RSD Route Selection Descriptor
RSRP Reference Signal Received Power
SA Standalone
SDAP Service Data Adaptation Protocol
SDU Service Data Unit
SGW Serving Gateway
SI System Information
SIM Subscriber Identity Module
SLA Service Level Agreement
SM Session Management
SMF Session Management Function
SN Secondary Node
SNPN Stand Alone Non-Public Network
S-NSSAI Single Network Slice Selection Assistance Information
SSB Synchronization Signal Block
SSM Source Specific IP Multicast address
SSC Session and Service Continuity
SRB Signaling Radio Bearer
SUPI Subscription Permanent Identifier
TA Tracking Area
TAG Timing Advance Group
TAI Tracking Area Identity
TE Terminal Equipment
TM Transparent Mode
TMGI Temporary Mobile Group Identity
TS Technical Specification
UDM Unified Data Manager
UDR Unified Data Repository
UE User Equipment
UL Uplink
UM Unacknowledged Mode
UP User Plane
UPF User Plane Function
URLLC Ultra-Reliable and Low-Latency Communication
URSP UE Route Selection Policy

1. A method performed by a network controlled repeater-mobile termination (NCR-MT) in a wireless communication network, the method comprising:
transmitting, to a base station, a radio resource control (RRC) resume request message;
receiving, from the base station, an RRC setup message as a response to the RRC resume request message; and
transmitting, to a network controlled repeater-forwarding function (NCR-Fwd), an indication to cease forwarding of a signal.

2. The method of claim 1,
wherein the NCR-MT is in an RRC inactive mode.

3. The method of claim 1, further comprising:
turning on the NCR-Fwd based on a last configuration received from the base station in case that the NCR-MT enters an RRC inactive state.

4. The method of claim 1,
wherein the NCR-Fwd is turned on before transmitting the RRC resume request message.

5. The method of claim 1, further comprising,
turning on the NCR-Fwd after an RRC resume procedure.

6. The method of claim 1,
wherein the transmitting the indication is indicated by a controlling network entity.

7. A network controlled repeater-mobile termination (NCR-MT) in a wireless communication network, the NCR-MT comprising:
a transceiver; and
a controller configured to:
transmit, to a base station, a radio resource control (RRC) resume request message,
receive, from the base station, an RRC setup message as a response to the RRC resume request message, and
transmit, to a network controlled repeater-forwarding function (NCR-Fwd), an indication to cease forwarding of a signal.

8. The NCR-MT of claim 7,
wherein the NCR-MT is in an RRC inactive mode.

9. The NCR-MT of claim 7,
wherein the controller is further configured to:
turn on the NCR-Fwd based on a last configuration received from the base station in case that the NCR-MT enters an RRC inactive state.

10. The NCR-MT of claim 7,
wherein the NCR-Fwd is turned on before transmitting the RRC resume request message

11. The NCR-MT of claim 7,
wherein the controller is further configured to:
turn on the NCR-Fwd after an RRC resume procedure.

12. The NCR-MT of claim 7,
wherein the transmitting the indication is indicated by a controlling network entity.
